(19) United States
(12) Patent Application Publication
(10) Pub. No.: US 2001/0016857 A1
(43) Pub. Date: Aug. 23, 2001

(54) Information processing device, information processing method and recording medium storing computer program for processing information

(76) Inventor: Toru Sorihashi, Nara-shi (JP)

Correspondence Address: Dike, Bronstein, Roberts & Cushman, Intellectual Property Practice Group, EDWARDS & ANGELL, P.O. Box 9169, Boston, MA, 02209, US

(21) Appl. No.: 09/757,726

(22) Filed: Jan. 10, 2001

(30) Foreign Application Priority Data
Jan. 14, 2000 (JP) 2000-7162

(51) Int. Cl. G06F 17/00

(52) U.S. Cl. 707/511

(57) ABSTRACT

A PC includes a DMS document editing section for creating document data, a member for making a reference to a material such as a reference document, and further includes a log recording/reproducing section which creates log data including history data of a member executed in creation processes of document data and reproduces an operation of each member executed in the creation of the document data according to the log data when displaying the document data. As a result, a reader can obtain detailed creation processes of the document data, which enables him to fully understand the creation processes of the data file such as document data, etc.

### FIELD OF THE INVENTION

The present invention generally relates to an information processing device and an information processing method for creating and displaying data file, and a recording medium storing a computer program for processing information.

### BACKGROUND OF THE INVENTION

Generally, in order to fully understand the content of a document, technical knowledge in the field of the document is often required. In response, techniques for annotating the document data to be displayed, for example, on a screen of a personal computer, or linking to reference document data have been proposed.

For example, Japanese Unexamined Patent Publication No. 175569/1999 (Tokukaihei 11-175569, published on Jul. 2, 1999 (U.S. Ser. No. 08/962,746)) discloses a system which permits subsidiary data such as annotation data or hyper link data, etc., to be added to a comment region of document data or data attached to the document data.

As another example, Japanese Unexamined Patent Publication No. 309303/1994 (Tokukaihei 6-309303, published on Nov. 4, 1994) discloses a word processor which permits repetitive input to be executed in a simple manner by storing input history for the creation of the document data. In this word processor, a reader can reproduce the creation of the document data in reference to the input history, and thus the reader can see the content of the document with ease.

However, in the system of Japanese Unexamined Patent Publication No. 175569/1999, auxiliary data is created by a writer (author) of the document data, and heavy burden is imposed on the author.

The auxiliary data created by the author may contain plenty of information for supporting the point of the content of the document. Generally, however, the auxiliary data hardly contains ideas, documents, etc., which are not directly relevant to the content of the complete document data. For this reasons, it is not possible for the reader of the document data to fully understand the process of developing author's ideas for the creation of the document data.

Namely, when adopting the foregoing conventional auxiliary data, it is not possible for the reader to read the information on all the documents the author referred to (document data), or the information on the descriptions in the document data considered by the author for the creation of the document data. Therefore, in the above system, accurate document data creation processes, i.e., the processes of wrapping up the author's ideas are not obtainable for the reader.

In the word processor disclosed by the above-discussed Japanese Unexamined Patent Publication No. 309303/1994, only an character input operation is stored as operation history. Namely, other operations than the character input operation executed for the creation of the document data, (such as referring to other document data, etc.,) cannot be stored or read. Therefore, as in the case of the aforementioned system, accurate document data creation processes and the background technique are not obtainable for the reader.

Moreover, according to the above word processor, other devices (word processor, CAD devices, search devices, etc.,) cannot be adopted for the creation of the document data. Therefore, the document data or the drawing data cannot be referred to using other device and thus document data as desired cannot be created.

### SUMMARY OF THE INVENTION

It is an object of the present invention to provide an information processing device and an information processing method for creating a data file such as document data, etc., which enables a reader to fully understand creation processes of the data file, and a recording medium storing a computer program for processing information.

In order to achieve the above object, the information processing device of the present invention (hereinafter referred to as the information processing device) for creating and displaying data file includes:

a data creating section for creating data file;

a data reference section for displaying reference data; and

a log recording/reproducing section which i) creates log data including history data of operations executed by the data creating section and the data reference section when creating the data file, and ii) controls the data creating section and the data reference section to re-execute the operations stored in the log data so as to reproduce a creation of the data file when displaying the data file.

In the above information processing section, the data creating section indicates a device for creating a data file such as document data, drawing data, etc. The data reference section indicates a device for displaying other data file (reference data) a user (writer of the data file) referred to when creating the data file to the user.

According to the above information processing device, the log recording/reproducing section stores as log data i) the operations executed by the data creating section when creating the data file (such as input of character/drawing, delete, insert, copy, paste) as well as ii) the operations executed by the data reference section when creating the data file (such as search, display and copy of reference data such as document data, drawing data, etc.) in order from the operation executed first.

Then, in the state the data file as completed is displayed, the log recording/reproducing section enables the reproduction of the operations executed by the data creating section and the data reference section when creating the data file based on an instruction given by the reader and the log data.

As a result, the reader can recognize the operation history such as input, deletion made with respect to the content of the data file as well as the reference material data or drawing data the author referred to when creating the data file. Therefore, according to the foregoing arrangement, the user can follow the processes of creating the data file with ease.

According to the foregoing document processing device, the writer (author) of the data file can provide readers the necessary information for their understanding of the data file such as the meaning of technical terms, specific symbols, etc., without a need of creating auxiliary data (note, etc.) on the contents of the data file.

In order to achieve the above object, the information processing method of the present invention (hereinafter referred to as the information processing method), for i) creating data file using a data creating section for creating data file and a data reference section for displaying reference data and ii) displaying the data file as created, includes:

(a) a log data creation step for creating log data including history data of operations executed by the data creating section and the data reference section when creating the data file; and

(b) a reproducing step for controlling the data creating section and the data reference section to re-execute the operations stored in the log data to reproduce a creation of data file.

The data creating section and the data reference section in the information processing method are as explained for the information processing device.

According to the foregoing information processing method, in the log data creation step, the operations executed by the data creating section and the data reference section when creating the data file are stored as log data in order from the operation executed first.

Further, in the state the data file as completed is displayed, the operations executed by the data creating section and the data reference section when creating the data file can be reproduced in the reproducing step based on an instruction given by the reader and the log data.

As a result, the reader can recognize the operation history such as input, deletion made with respect to the content of the data file as well as the materials referred to when creating the document data. Therefore, according to the forgoing arrangement, the user can follow the processes of creating the document data with ease.

According to the foregoing document processing device, the writer (author) of the data file can provide readers the necessary information for their understanding of the data file such as the meaning of technical terms, specific symbols, etc., without a need of creating auxiliary data (note, etc.) on the contents of the data file.

In order to achieve the above object, the recording medium of the present invention storing a computer program for processing information, which i) creates data file using a data creating section for creating a data file and a data reference section for displaying reference data, and ii) displays a data file as created is arranged so as to realize a reproduction of a creation of the data file by creating log data including history data of operations executed by the data creating section and the data reference section when creating the data file, and re-executing the operations as stored in the log data by the data creating section and the data reference section.

By installing the above recording medium in the control device provided in a generally used information processing device such as a personal computer, etc., the foregoing information processing device and the information processing method of the present invention can be realized with ease.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is an explanatory view showing a structure of PC (PC/WS) as an information processing device in accordance with the first embodiment of the present invention.

FIG. 2 is an explanatory view showing a structure of a document processing system adopting the PC shown in FIG. 1.

FIG. 3 is an explanatory view showing a structure of a DMS document search section adopted in the PC shown in FIG. 1.

FIG. 4 is an explanatory view showing a structure of a document search section and a DMS proxy provided in the PC shown in FIG. 1.

FIG. 5 is an explanatory view showing an example of log data created by a log recording/reproducing section provided in the PC shown in FIG. 1.

FIG. 6 is an explanatory view showing a document data creating screen and a reference data display screen in the PC shown in FIG. 1.

FIG. 7(a) is an explanatory view showing a creation screen of a display device which displays document data being created in the PC shown in FIG. 1

FIG. 7(b) is an explanatory view showing a memory state regarding position indicative information of each sentence in a log recording/reproducing section of the PC shown in FIG. 1.

FIG. 7(c) is an explanatory view showing another memory state regarding position indicative information of each sentence in the log recording/reproducing section of the PC shown in FIG. 1.

FIG. 7(d) is an explanatory view showing other creation screen of a display device for displaying document data being created in the PC shown in FIG. 1.

FIG. 7(e) is an explanatory view showing still another recording state regarding position indicative information of each sentence in the log recording/reproducing section of the PC shown in FIG. 1.

FIG. 8 is an explanatory view showing log data created by the log recording/reproducing section provided in the PC shown in FIG. 1, which contains position indicative information.

FIG. 9 is an explanatory view showing another example of log data created by the log recording and reproducing section provided in the PC shown in FIG. 1.

FIG. 10 is an explanatory view showing still another example of the log data created by the log recording/reproducing section provided in the PC shown in FIG. 1.

FIG. 11 is an explanatory view showing document data creation screen in the PC shown in FIG. 1.

FIG. 12 is an explanatory view showing an example of log data created by the log recording/reproducing section provided in the PC shown in FIG. 1, in which the position indicative information are marked.

FIG. 13 is an explanatory view showing an example of log data created by the log recording/reproducing section provided in the PC shown in FIG. 1, in which the marking shown in FIG. 12 is deleted.

FIG. 14 is an explanatory view showing the structure of an input/output control section shown in FIG. 3 and FIG. 4.

FIG. 15 is an explanatory view showing log data created by the log recording/reproducing section provided in the PC shown in FIG. 1 and the log data including information indicative of the display state of the display device.

FIG. 16 is an input screen for setting conditions on the display state of a screen, by which whether the screen on the display device is stored in the log data is determined.

FIG. 17 is an explanatory view showing the structure of the log recording/reproducing section provided in the PC shown in FIG. 1.

FIG. 18 is an explanatory view showing an example of a list of main recording members registered in a main recording member registering section of the log recording/reproducing section shown in FIG. 17.

FIG. 19 is an explanatory view showing an example of log data created by the log recording/reproducing section shown in FIG. 17.

FIG. 20 is an explanatory view showing an example of the log data shown in FIG. 19, in which a portion of the operation is determined to be invalid.

FIG. 21 is an explanatory view showing another example of the log data shown in FIG. 19, in which a portion of the operation is determined to be invalid.

FIG. 22 is an explanatory view showing the memory state of log data and document data in the PC shown in FIG. 1.

FIG. 23 is an explanatory view showing another structure of the document processing system in accordance with one embodiment of the present invention.

### DESCRIPTION OF THE EMBODIMENTS

### [First Embodiment]

The following descriptions will explain the first embodiment of the present invention.

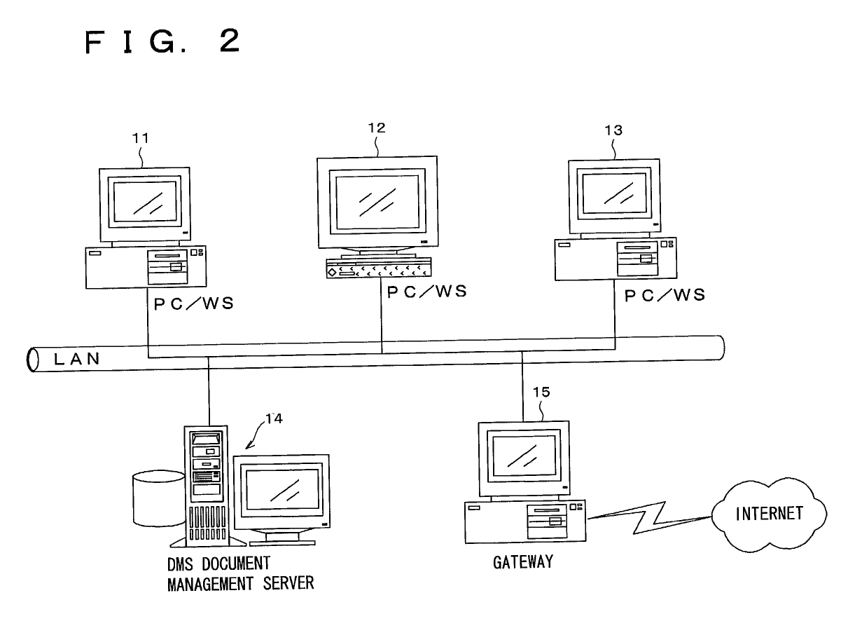

FIG. 2 is an explanatory view showing a schematic structure of a document processing system (hereinafter simply referred to as a system) in accordance with the present embodiment. As shown in FIG. 2, the system of the present embodiment includes PC/WS (personal computer/work station: hereinafter referred to as PCs) 11 to 13, a DMS document management server 14, and a gateway 15 which are provided on a LAN (Local Area Network).

The gateway 15 is a gate provided between the system of the present embodiment and the network of the external section.

Each of the PCs (information processing devices) 11 to 13 includes a data creating section for creating document data (data file) and a data referring section for displaying the reference data.

Here, the data creating section indicates a device for creating description contents of the document data such as a word processor, a CAD device, a graph creating device, etc. The data reference section indicates a device for displaying data the user (writer of the document data) wishes to refer to (reference data: reference material data, drawing data, etc.,) when creating the document data, examples of which include a data search device, a data display device, etc.

Each of the PCs 11 to 13 has a function of creating the document data by controlling the data creating section and the data reference section and executing the operations of the user as desired. In the PCs 11 to 13, the document data as created can be displayed by the display device (to be described later).

Concrete examples of the data creating section and the data reference section provided in each of the PCs 11 to 13 will be explained in detail later.

The DMS document management server (data memory section) 14 is provided with a document management system (hereinafter referred to as DMS). The DMS document management server 14 stores and controls the document data created by the PCs 11 to 13, and the log data to be described later. The DMS is a system for exclusively controlling the storage and the fetch of the document data by each edition. The DMS is also provided with a search function.

The DMS document management server 14 also has a function of storing the data regarding the data creating section and the data reference section (document data, reference data) provided in each of the PCs 11 to 13.

Next, the structures of the PCs 11 to 13 which are the characteristic structures of the system of the present embodiment will be explained.

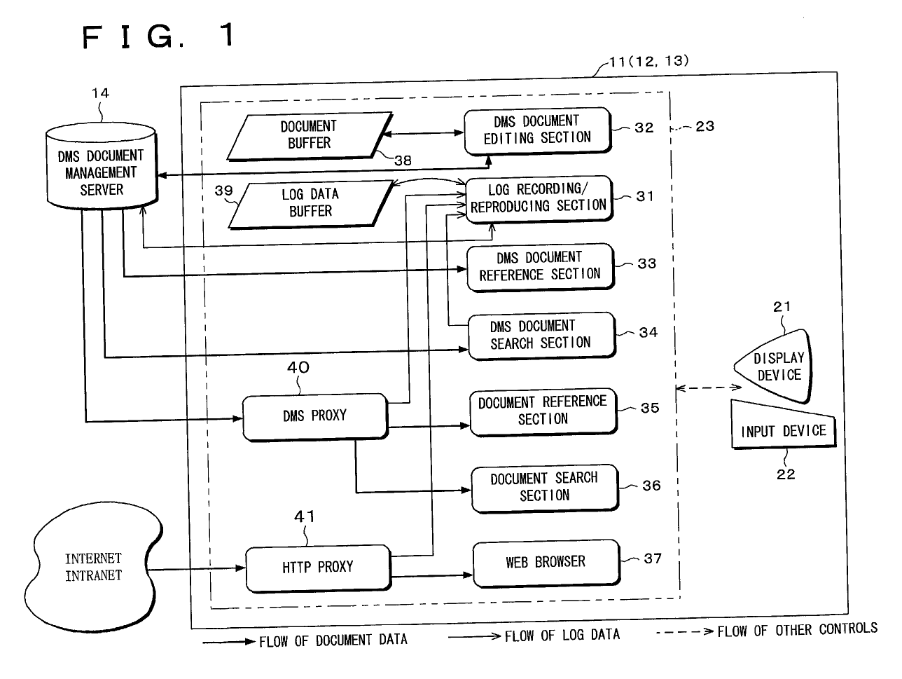

FIG. 1 is an explanatory view showing the structure of the PC 11 (PCs 12, 13). As shown in FIG. 1, the PC 11 includes a display device 21, an input device 22, and a control device 23.

The display device 21 is provided with a function of displaying document data created by the PC 11, or the data regarding the data creating section and the data reference section, or the like. The display device 21 is composed of a CRT (Cathode-Ray Tube) or an LCD (Liquid Crystal Display).

The input device 22 is provided for transmitting inputs made by the user to the control device 23. The input device 22 is constituted by a keyboard and a mouse.

The control section 23 which constitutes an essential part of the PC 11 is provided with the data creating section and the data reference section. The control section 23 has a function of driving the DMS document management server 14 and the display device 21 and creating/displaying the document data and the reference data based on an instruction given by the user by means of the input device 22.

The document control section 23 has a function of creating log data in accordance with the creation of the document data.

The log data includes the history data of all the operations executed when creating one piece of document data by the data creating section and the data reference section in the control section 23. This control section 23 has a function of reproducing the creation of the document data based on the log data.

As shown in FIG. 1, the control device 23 includes a log recording/reproducing section 31, a DMS document editing section 32, a DMS document reference section 33, a DMS document search section 34, a document reference section 35, a document search section 36, a WEB browser 37, a document buffer 38, a log data buffer 39, a DMS proxy 40, and a HTTP proxy 41.

Among all, the DMS document editing section 32 serves as a data creating section in the PC 11. The DMS document reference section 33, the DMS document search section 34, the document reference section 35, the document search section 36, and the WEB browser 37 serve as the data reference section in the PC 11.

The DMS document editing section 32 serves as a document creating/editing device (word processor) for creating the document data according to an instruction given a user by means of the input device 22. In the creation (editing) process of the document data, the DMS document editing section 32 temporarily stores the document data in the document buffer 38. Then, after completing the creation of the document data, the document data is stored/controlled by the DMS document management server 14.

The DMS document search section 34 is provided for searching (finding out) the reference data the user desires in the DMS document management server 14 based on an instruction given by the user. The DMS document reference section 33 is provided for displaying the reference data as searched by the DMS document search section 34 in the display device 21. The DMS document reference section 33 also has a function of searching characters in the reference data displayed in the display device 21.

As in the DMS document search section 34, the document search section 36 searches the reference data in the DMS document management server 14. Similarly, as in the DMS document reference section 33, the document reference section 35 displays the reference data as searched by the document search section 36 in the display device 21, and performs a character search in the reference data.

The WEB browser 37 confirms a connection with the external network via the gateway 15 shown in FIG. 2, and functions as a browser for referring to a WWW (World Wide Web) server, etc.

The DMS document editing section 32, the DMS document reference section 33, the DMS document search section 34, the document reference section 35, the document search section 36 and the WEB browser 37 are provided for creating or referring to the data according to an instruction given by the user. Therefore, these devices are referred to as general term for application devices (APs).

Among these APs 32 to 37, the DMS document editing section 32, the DMS document reference section 33 and the DMS document search section 34, each has a function of creating history data (operation history data) of all the operations it executed and transmitting the data as created to the log recording/reproducing section 31.

On the other hand, the document reference section 35, the document search section 36 and the WEB browser 37 are not provided with a function of creating the history data of the operations they executed. Namely, these APs 35 to 37 are generally used data reference devices.

In order to obtain the operation history data of the document reference section 35, the document search section 36 and the WEB browser 37, the PC 11 is provided with the DMS proxy 40 and the HTTP (Hyper Text Transfer Protocol) proxy 41.

Namely, these proxies (operation supervision sections) 40, 41 create the history data (operation history data) of all the operations executed by the document reference section 35, the document search section 36 and the WEB browser 37, and transmit the data as created to the log recording/reproducing section 31.

The log recording/reproducing section 31 creates and edits the log data based on the operation history data transmitted from the DMS document editing section 32, the DMS document reference section 33, the DMS document search section 34 and the proxies 40, 41.

Further, the log recording/reproducing section 31 has a function of controlling the APs 32 to 37 to re-execute all the operations stored in the log data according to an instruction given by the user.

While the document data is being created, the log recording/reproducing section 31 temporarily stores the log data according to the document data in the log data buffer 39. Additionally, upon completing the creation of the document data, the storage of the log data is controlled by the DMS document management server 14.

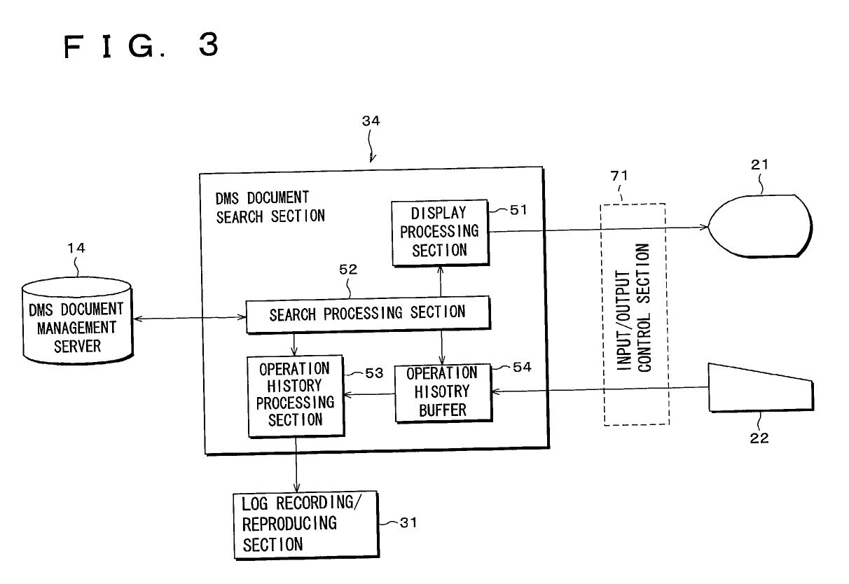

Here, the structure of the DMS document search section 34 provided with a function of creating history data of operations it executed will be explained. FIG. 3 is an explanatory view showing the schematic structure of the DMS document search section 34. As shown in the Figure, the DMS document search section 34 includes a display processing section 51, a search processing section 52, an operation history processing section 53 and an operation history buffer 54.

The search processing section 52 is provided for searching the DMS document management server 14 according to an instruction given by the user. The display processing section 51 displays the result of search by the search processing section 52 in the display device 21. The operation history buffer (operation history data creating section) 54 is a memory for storing the history data of all the operations executed by the display processing section 51 and the search processing section 52.

The operation history processing section (operation history data creating section) 53 wraps up the history data of all the operations executed by the display processing section 51 and the search processing section 52 to create the operation history data of the DMS document search section 34. Then, the operation history data as created is transmitted to the log recording/reproducing section 31.

The DMS document editing section 32 and the DMS document reference section 33 are also provided with the operation history processing section 53 and the operation history buffer 54 for wrapping up the history data of all the operations they executed to complete the history data.

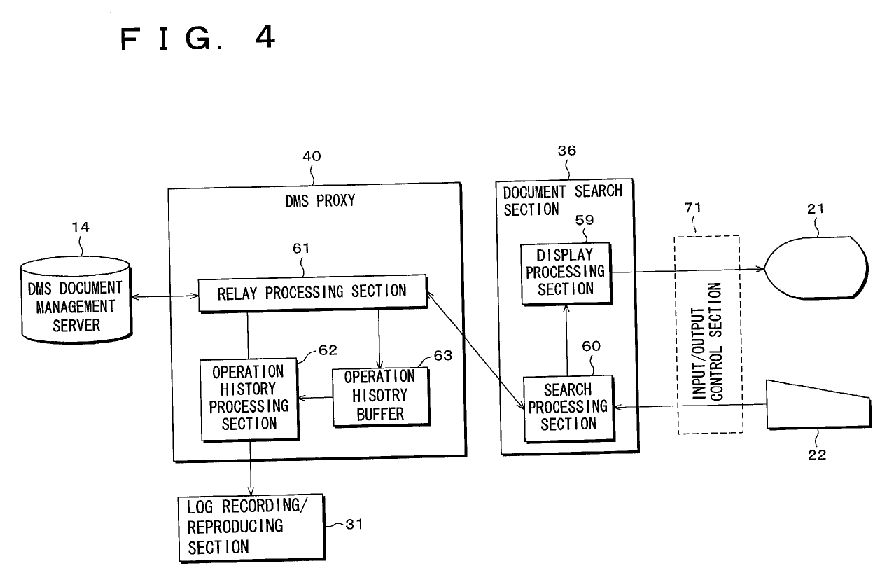

Next, the structure of the document search section 36 which is not provided with a function of creating the history data of operations it executed will be explained. FIG. 4 is an explanatory view showing the structure of the document search section 36 and the DMS proxy 40. As shown in the FIG. 4, the document search section 36 is provided with a display processing section 59 and a search processing section 60. The DMS proxy 40 includes a relay processing section 61, an operation history processing section 62 and an operation history buffer 63.

The search processing section 60 in the document search section 36 is provided for searching the reference data in the DMS document management server 14 according to an instruction given by the user. The display processing section 59 is provided for displaying the reference data as searched by the search processing section 60 in the display device 21.

The relay processing section 61 of the DMS proxy 40 relays the search operation with respect to the DMS document management server 14 by the search processing section 60, and controls the operation history buffer (operation supervision section) 63 to store the contents of the operations executed by the search processing section 60 which relays. The operation history processing section (operation supervision section) 62 creates log data of operations executed by the document search section 36 (operation history data) by wrapping up all the operations of the search processing section 60 relayed by the relay processing section 61, and transmits the log data as created to the log recording/reproducing section 31.

The DMS proxy 40 relays the operation of the document reference section 35, and wraps up the operation history to create the operation history data of the document reference section 35 to be transmitted to the log recording and reproducing section 31.

Further, the HTTP proxy 41 is also provided with the relay processing section 61, the operation history processing section 62 and the operation history buffer 63 for wrapping up the operation history to create the operation history data to be transmitted to the log recording/reproducing section 31 after relaying the operations executed by the WEB browser 37.

The operation history processing section 53 shown by FIG. 3 and the operation history processing section 62 shown in FIG. 4 are arranged so as to wrap up the operation history data by a predetermined unit (transaction) to be transmitted to the recording/reproducing section 31. Therefore, the log recording and reproducing section 31 receives the operation history data wrapped up by a predetermined unit and sequentially creates the log data based on the data as received.

As to an input/output control section 71 shown in FIG. 3 and FIG. 4, detailed explanations will be given through the third embodiment.

The display device 21 shown in FIG. 1 is arranged such that a plurality of display screens (windows) can be opened according to respective requests given by the AP 32 to AP 37. Therefore, the user can open a display screen for reference data on the display device 21 together with a screen for creating document data.

Next, operations of the PC 11 will be explained.

In the following explanations, operations executed by the document reference section 35, the document search section 36 and the WEB browser 37 are treated as the operations executed by the DMS proxy 40 or the HTTP proxy 41.

The following Table 1 shows concrete examples of the operations executed by the DMS document editing section 32, DMS document reference section 33, the DMS document search section 34, the DMS proxy 40 and the HTTP proxy 41, which are written in the log data.

TABLE 1

| | Operation | |
|---|---|---|
| AP · PROXY | Content | Operation Information |
| DMS Document | Start | |
| Editing Section | Creation | |
| DMS Document | Manual Input | Cursor Position, Insert |
| Editing Section | | Character/Drawing |
| DMS Document | Paste | Cursor Position, Paste |
| Editing Section | | Character/Drawing |
| DMS Document | Delete | Cursor Position, Delete |
| Editing Section | | Character/Drawing |
| DMS Document | Move Cursor | Cursor Position |
| Editing Section | | |
| DMS Document | Search | Cursor Position, Keyword, |
| Editing Section | Character | Result Position |
| DMS Document | Close | DMS Name, |
| Editing Section | | Store Document Name |
| DMS Document | Start Display | DMS Name, Reference Data |
| Reference Section | | Name, Version |
| DMS Document | Move Cursor | Cursor Position |
| Reference Section | | |
| DMS Document | Copy | Cursor Position, Copy |
| Reference Section | | Character/Drawing |
| DMS Document | Search | Cursor Position, Keyword, |
| Reference Section | | Character Result Position |
| DMS Document | Close | |
| Reference Section | | |
| DMS Document | Search | DMS Name, Original DINA set, |
| Search Section | | Keyword and |
| | | Resulting DINA set |
| DMS Document | Instruct | Reference Data Name of |
| Search Section | Display | Objective of Display |
| | | Instruction |
| DMS Document | Close | |
| Search Section | | |
| DMS PROXY | Start Display | DMS Name, Reference Data |
| | | Name, Version |
| DMS PROXY | Search | DMS Name, Keyword |
| HTTP PROXY | Request | URL (including CGI |
| | | Parameter) |
| HTTP PROXY | Receive | HTML Document Content |

In the above Table, the operation information indicates contents of instructions the user inputs into the APs 32 to 34, and the proxies 40 and 41 by means of the input device 22. Namely, the APs 32 to 34 and the proxies 40 and 41 execute operations based on the operation information.

Therefore, in the PC 11, the respective operations can be reproduced by controlling the APs 32 to 34 and the proxies 40 and 41 based on the operation information.

In Table 1, the “DMS name” described as operation information is a general term for the reference data set by the DMS of the DMS document management server 14. The “DINA set” is a group of records as a search object or a search result. In the PCs 11 to 13, the “DINA set” is indicated by a group of keys for data compression.

Additionally, the “URL (Uniform Resource Locator)” is the information indicative of an address of each server (WWW server) on the WWW network. Additionally, “CGI (Common Gateway Interface) parameter” is a parameter required for transmitting/receiving information among WWW servers.

Additionally, “HTML document” is a document on the WWW network constituted by the HTML (Hyper Text Markup Language) system.

A concrete example for a creation of log data (log data creation process) by the log recording/reproducing section 31 will be explained.

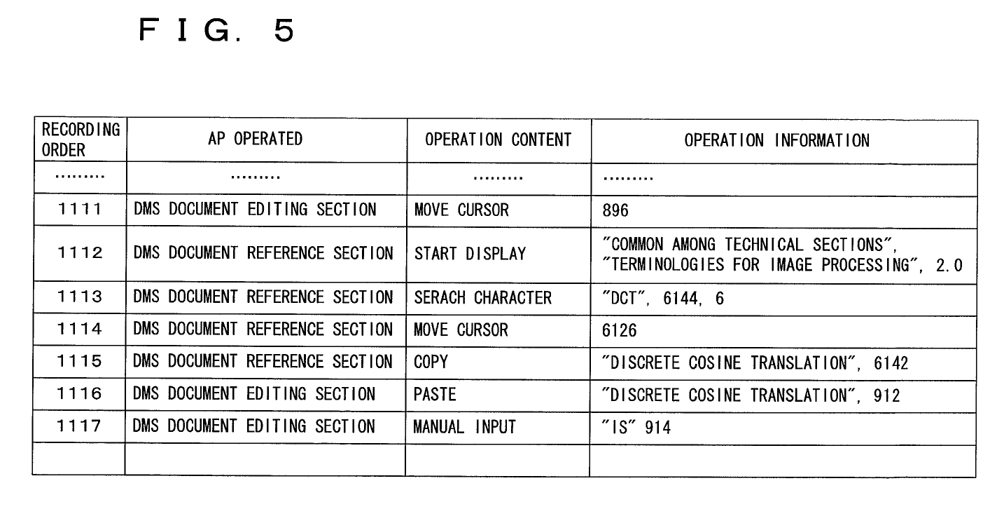

FIG. 5 is an explanatory view showing an example of the log data actually created by the log recording/reproducing section 31. As shown in FIG. 5, the log data contains sequential numbers (recording order) indicative of the order of executing respective operations, names of APs used, operation contents and operation information.

As shown in Table 1, numbers in the operation information indicate respective positions in the document data or reference data (cursor position: “896” in the recording order 1111, etc.,), data length “6” in the recording order 1113) of the word (character string) obtained by the search, or the version number of the reference data (“2. 0” in the recording order 1112).

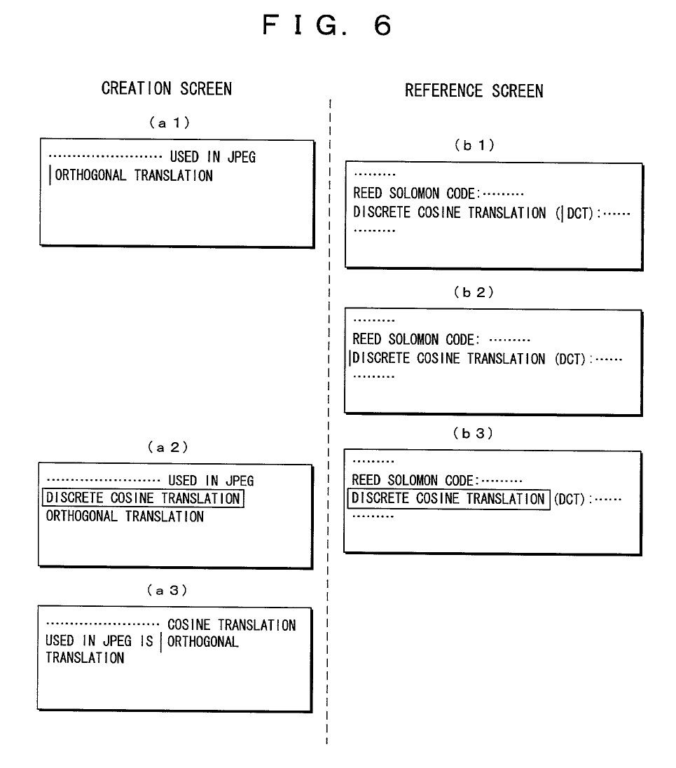

Next, examples of the creating (editing) processes of the document data by the PC 11 will be explained using (a1) to (a3), and (b1) to (b3) in FIG. 6.

(a1) to (a3) in FIG. 6 are explanatory views showing document data creating screens (screen (window) of the DMS document editing section 32: creation screen). (b1) to (b3) in FIG. 6 are explanatory views showing display screens of the reference data (screen of the DMS document reference section 33: reference screen).

In the examples of the document data creating processes shown in (a1) to (a3) and (b1) to (b3) in FIG. 6, the user searches words (characters) on “orthogonal exchange” in the reference data and inputs the words as searched in the document data to explain the phrase “USED IN JPEG ORTHOGONAL TRANSLATION” in the document data shown in (a1) of FIG. 6. Additionally, the log data shown in FIG. 5 is an example of the creation process.

In this example, processes following the search of the related reference data (DMS name “common among technique sections”, reference data name “terminologies for image processing”, and a version number “2, 0”) from the DMS document control server 14, which is performed by the user by controlling the DMS document search section 34 are shown.

In this example, first, the user moves the cursor as shown by (a1) in FIG. 6 in the creation screen. Then, the DMS document reference section 33 is controlled to search the word “orthogonal exchange”, and the above reference data as already read out is displayed on the reference screen of the display device 21.

Then, the user inputs an instruction for searching “DCT” indicative of “orthogonal translation” into the DMS document reference section 33. Thereafter, this DMS document reference section 33 starts a character search in the reference data by a keyword “DCT”.

As a search result, the reference screen in the display device 21 displays the screen as shown in (b1) in FIG. 6. Then, as shown in (b2) and (b3) in FIG. 6, the user moves the cursor in the reference screen by controlling the DMS document reference section 33, to copy “discrete cosine translation” for “DCT”.

Thereafter, the user controls the DMS document editing section 32 as shown in (a2) in FIG. 6, and pastes (inserts) the “discrete cosine translation” in the document data creation screen. Lastly, as shown in (a3) in FIG. 6, the user inserts a be-verb “is” to complete a sentence by a manual input (input by means of a keyboard).

After the above sequential process, the DMS document editing section 32, the DMS document reference section 33 and the DMS document search section 34 create operation history data by themselves, and transmit the respective operation history data as created to the log recording/reproducing section 31. Then, the log recording/reproducing section 31 reads the log data from the log data buffer 39 and edit the log data as read based on the history data as received.

Namely, first, the log recording/reproducing section 31 reads out the log data according to the document data from the log data buffer 39 (or DMS document management server 14). Thereafter, the operation of moving the cursor ((a1) in FIG. 6) in the DMS document editing section 32 is stored in the recording order “1111” in the log data shown in FIG. 5.

Then, the display of the reference data, the character search, the cursor movement and the copy operations ((b1) to (b3) in FIG. 6) by the DMS document reference section 33 are stored in the recording order “11112” to “1115” in the log data.

Furthermore, the log recording/reproducing section 31 records the paste and the manual input operation by the DMS document editing section 32 in the recording order “1116” to “1117” in the log data of FIG. 5. Then, the log recording/reproducing section 31 records the log data in the log data buffer 39.

Thereafter, upon completing the creation of the document data, the DMS document editing section 32 records the document data in the DMS document management server 14. In this state, the log recording/reproducing section 31 transmits the log data stored in the log data buffer 39 to the DMS document management server 14 to be stored therein, thereby completing the log data creation process.

Next, reproducing processes (reproducing step) of the creation of the document data by the log recording/reproducing section 31 will be explained.

The reproduction of the document data creation process is performed when displaying (viewing) the document data. Namely, first, a reader (including a writer (author) of the data file) inputs an instruction for displaying the document data the user wishes to view in the DMS document reference section 33 and the DMS document search section 34 via the input device 22.

As a result, the document data as desired is searched from the DMS document management server 14 by the DMS document search section 34. Further, the document data as searched is displayed on the display device 21 by the DMS document reference section 33.

Thereafter, in the case where the reader wishes for the reproduction of the document data creating process, the reader inputs an instruction for reproducing the document data creating process to the log recording/reproducing section 31 via the input device 22.

Then, according to the instruction as input, the log recording/reproducing section 31 obtains the log data according to the document data as displayed from the DMS document management server 14. Then, based on the log data thus obtained, the log recording/reproducing section 31 controls the APs 32 to 34 and the DMS proxies 40 and 41 to re-execute all the operations executed when creating the document data, thereby reproducing the document data creation process. In this case, in the display device 21, the creation screen and the reference screen as shown in (a1) to (a3), and (b1) to (b3) in FIG. 6 are displayed.

As described, in the PC 11, the log recording/reproducing section 31 creates the log data of the data creating section and the data reference section used in the creation of the document data, i.e., the DMS document editing section 32, the DMS document reference section 33, and the DMS document search section 34; and the DMS proxy 40 and the HTTP proxy 41 (or the document search section 36, the WEB browser 37).

Then, according to an instruction given by the reader, the log recording/reproducing section 31 controls the respective APs 32 to 37 to re-execute the operations recorded in this log data according to an instruction given by the reader to reproduce the creation of the document data.

With the foregoing arrangement, the reader can see the data on the materials referred to in the creation of the document data or the reference data such as the drawing data, etc., with ease. Therefore, according to the PC 11 of the present embodiment, the user (writer of the document data) can offer the information required for the understanding of the document data such as meaning of technical terms, special symbols, etc., to the reader without creating the auxiliary data (note, etc.) regarding the description content of the document data.

When creating the document data, the log recording/reproducing section 31 stores in the log data all the operations executed by the respective APs 32 to 37 (or the proxies 40 and 41). Then, when displaying the document data, all the operations in the log data are reproduced so as to reproduce all the document data creation processes.

With the foregoing structure, the content deleted from the document data or the background document, etc., referred to in the document data creating process can be provided, and the detailed document data creating processes become obtainable for the reader. Therefore, it is possible for the reader to fully understand the document data creation processes including the ideas the author adopted for the creation of the document data. Also for the author of the document data, the above log data reminds the author of the creation processes of the document data created in the past.

Among the APs 32 to 37, each of the DMS document editing section 32, the DMS document reference section 33 and the DMS document search section 34 is provided with the operation history processing section 53 and the operation history buffer 54.

Therefore, as each of the above APs has a function of creating its own operation history data, detailed log data can be created by the log recording/reproducing section 31.

Further, the PC 11 is provided with the DMS proxy 40 and the HTTP proxy 41 (AP supervision section) having functions of creating the operation history data of the operations executed by the document reference section 35 and the document search section 36 and transmitting the operation history data as created to the log recording/reproducing section 31.

As a result, even when creating the document data adopting the generally used data reference section which is not provided with the operation history processing section 53 or the operation history buffer 54, etc., the log data can be created by the log recording/reproducing section 31.

### [Second Embodiment]

The following descriptions will explain the second embodiment of the present invention. In this embodiment, the structures having the same functions as those of the previous embodiment will be designated by the same codes and their descriptions will be omitted.

In the first embodiment, when creating the document data, the log recording/reproducing section 31 creates the log data of all the operations executed by the APs 32 to 37 (see FIG. 1) for the creation of the document data. When displaying the document data, the log recording/reproducing section 31 controls the APs 32 to 37 to reproduce all the operations executed for the creation of the data based on an instruction given by the reader and the log data, thereby permitting the creation of the document data to be reproduced completely.

The present embodiment differs from the first embodiment in that in the state the document data is displayed, the reproduction of document data creating process is performed by a unit of partial data selected by the reader. Here, the partial data indicates a part of the data file, such as a chapter, a page, a sentence, a word, a character, etc. In the following example, explanations will be given through the case of adopting a sentence as a unit of partial data.

In this example, when creating the document data, the log recording/reproducing section 31 stores a position (range) of each sentence in the data. Further, when storing operations executed by the respective APs 32 to 37, respective positions of characters related to each operation are stored in the log data as position indicative information for each operation.

Here, the characters related to each operation indicate characters (input result of each operation) input (created) through the operation or characters being input (being created) during the operation. In this example, the log recording/reproducing section 31 adopts as a unit of a position for a sentence or a character, the number of bytes counted from the first character in the document data (address in the buffer; 2 bytes/character for Chinese character code).

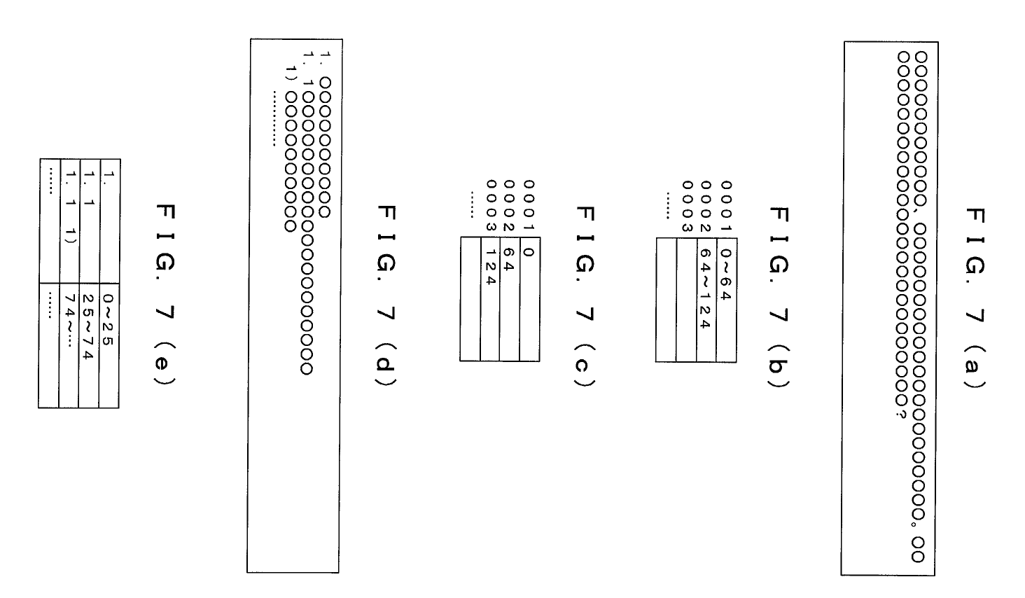

For example, FIG. 7(a) is an explanatory view showing a creation screen of the display device 21 which displays document data being created. As shown in FIG. 7(a), this document data contains two sentences ended with a period “.”, and a question mark “?” respectively.

Then, the log recording/reproducing section 31 creates the sentence-position correspondence table shown in FIG. 7(b) to be stored in the log data buffer 39. In this Figure, “0001”, “0002” . . . indicate sentence numbers, and “0 to 64” and “64 to 124” indicate the ranges for the respective sentences in the document data.

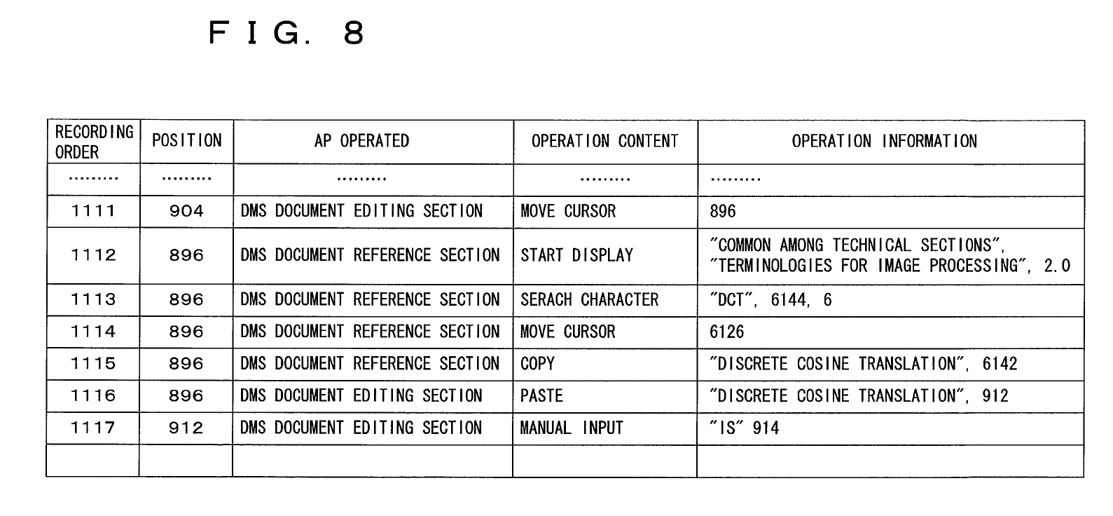

Further, as shown in FIG. 8, the log recording/reproducing section 31 stores the position of a character related to each operation in the column “position” of the log data, as position indicative information of each operation.

In the state where the document data is displayed, whether a reader wishes for the reproduction of the creation process for one sentence in the document data (for example, a sentence number “00001”), the reader drags (selects) the corresponding sentence in the range of “0 to 64” in the document data by means of the input device 22.

In response to the above dragging of the sentence, the log recording/reproducing section 31 obtains the range of the sentence as dragged based on the sentence-position correspondence table. Then, the operation for the position indicative information contained in the range is selected from the log data. Thereafter, the log recording/reproducing section 31 controls respective APs 32 to 37 (see FIG. 1) based on the log data as selected so as to reproduce the creation of the sentence (the sentence number “0001”).

As described, in the present embodiment, when displaying the document data, the log recording/reproducing section 31 reproduces the creation process of the sentence selected by the reader. According to this arrangement, only the part (arbitrary part) as selected by the reader can be reproduced without reproducing the unwanted part, thereby permitting a reduction in reference time.

Additionally, when creating the document data, the log recording/reproducing section 31 stores the position of the document data in the portion (character) related to each operation in the log data as position indicative information of each operation. As a result, when reproducing the part selected by the user, the operation related to the corresponding part can be extracted from the log data with ease.

In the above example, the log recording/reproducing section 31 creates the character-position correspondence table as shown in FIG. 7(b), and stores the written range of each sentence. However, the present invention is not limited to the above arrangement, and, for example, it may be arranged such that the recording/reproducing section 31 creates and stores the correspondence Table storing only a start of each sentence as shown in FIG. 7(c).

In the foregoing example of the present embodiment, explanations have been given through the case of reproducing the creation process of the document data by a unit of a sentence as selected by the reader as partial data unit. However, the present invention is not limited to this arrangement, and, for example, as shown in FIGS. 7(d) and 7(e), an index may be adopted as the partial data unit, wherein the document data creation process is reproduced by a partial data unit of a sentence.

In this example, in the state the document data is displayed, the reader drags (selects) the index for the part he wishes to reproduce by means of the input device 22. In response to this dragging, the log recording/reproducing section 31 specifies the range for the index as selected based on the correspondence Table shown in FIG. 7(e). Then, the log recording/reproducing section 31 selects the operation for the position indicative information in the specified range from the log data, and reproduces the operation as selected by controlling the APs 32 to 37 (see FIG. 1) respectively. As a result, the creation of the sentence for the index as selected can be reproduced.

Alternatively, a word may be adopted as a partial data unit. In this case, a Table correlating each word with the position is stored in the log data buffer 39, and the creation process is reproduced by a word as selected by the reader.

Alternatively, a chapter or a page may be adopted as a partial data unit. In this case, a Table correlating each chapter or page with the position is stored in the log data buffer 39, and the creation process is reproduced by a unit of a chapter number or a page number as selected by the reader.

It may be also arranged such that the partial data unit can be set as desired by the user (writer of the document data).

It may be also arranged such that a plurality of partial data can be selected simultaneously. In this case, upon selecting a plurality of partial data, the log recording/reproducing section 31 reproduces the creation processes for all the partial data as selected.

It is preferable that when the position of each character is changed as a result of making an insertion or deletion with respect to the document data, and the log recording/reproducing section 31 can change the position indicative information of the operation related to the character as necessary.

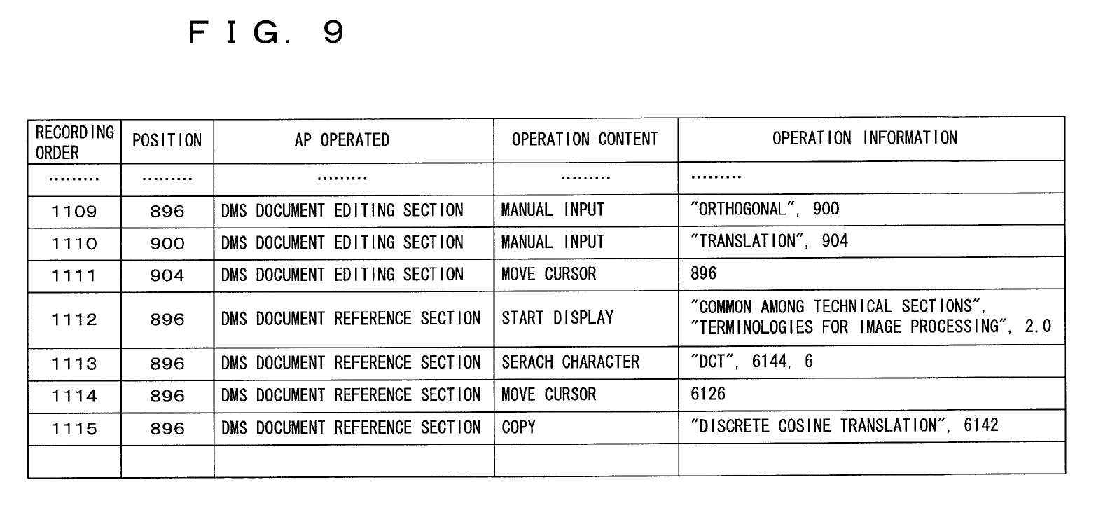

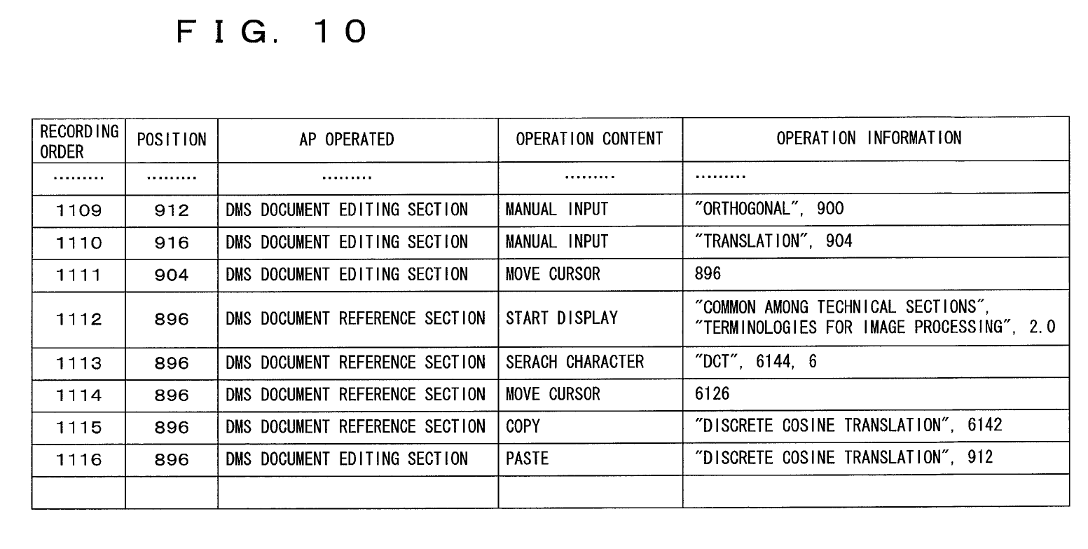

For example, FIG. 9 and FIG. 10 show the log data of the document data creating processes of (a1) to (a3), and (b1) to (b3) in FIG. 6, wherein FIG. 9 shows the log data for the operations up to the copying of the “discrete cosine translation” from the reference screen, while FIG. 10 shows the log data for operations subsequent to the copying operation up to the operation of pasting “discrete cosine translation” to the document data. As shown in these Figures, after pasting the “discrete cosine translation”, the position indicative information of each operation is rewritten in accordance with the paste.

By rewriting the position indicative information in the foregoing manner, correct correlations between the positions of respective characters and the position indicative information of the operation related to each character can be maintained.

In the case of deleting a character from the document data, it is preferable to mark the position indicative information for the operation related to the deleted character with a predetermined mark. Then, once the deleted character is recovered, the mark is deleted.

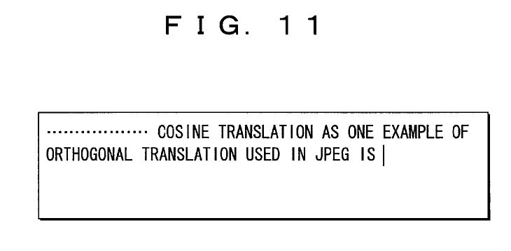

For example, the document data creation processes explained in reference to (a1) to (a3), and (b1) to (b3) in FIG. 6 are performed to create a sentence shown in FIG. 11, and the part “discrete cosine translation is” is deleted.

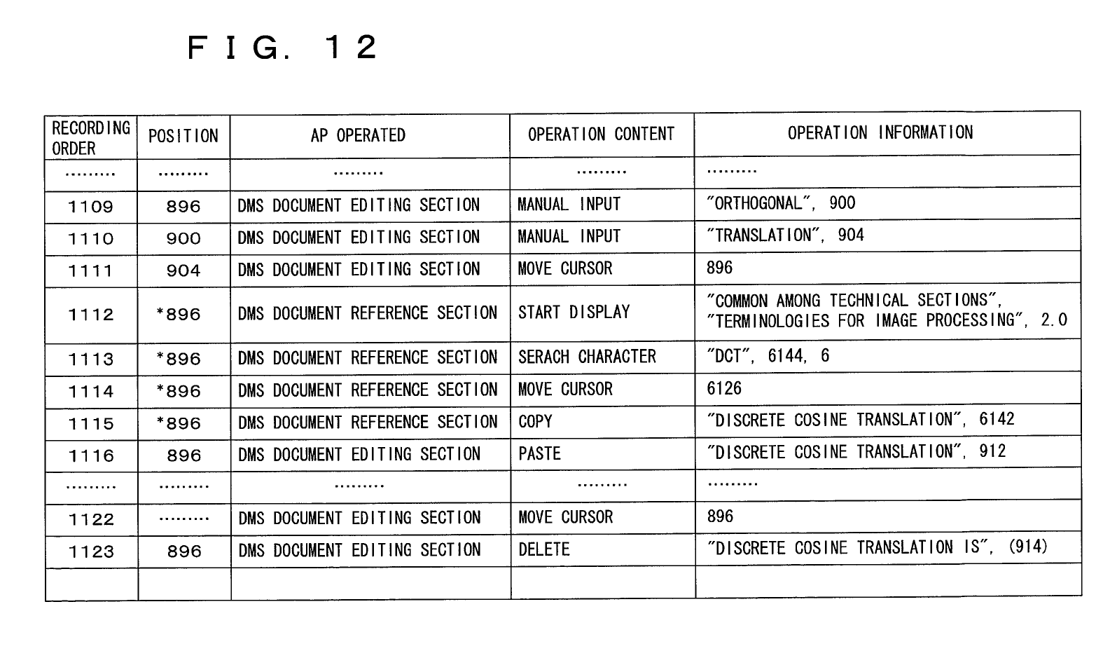

In this case, as shown in FIG. 12, in the log data, the mark “*” is added to the position indicative information for the operation corresponding to “discrete cosine translation is”.

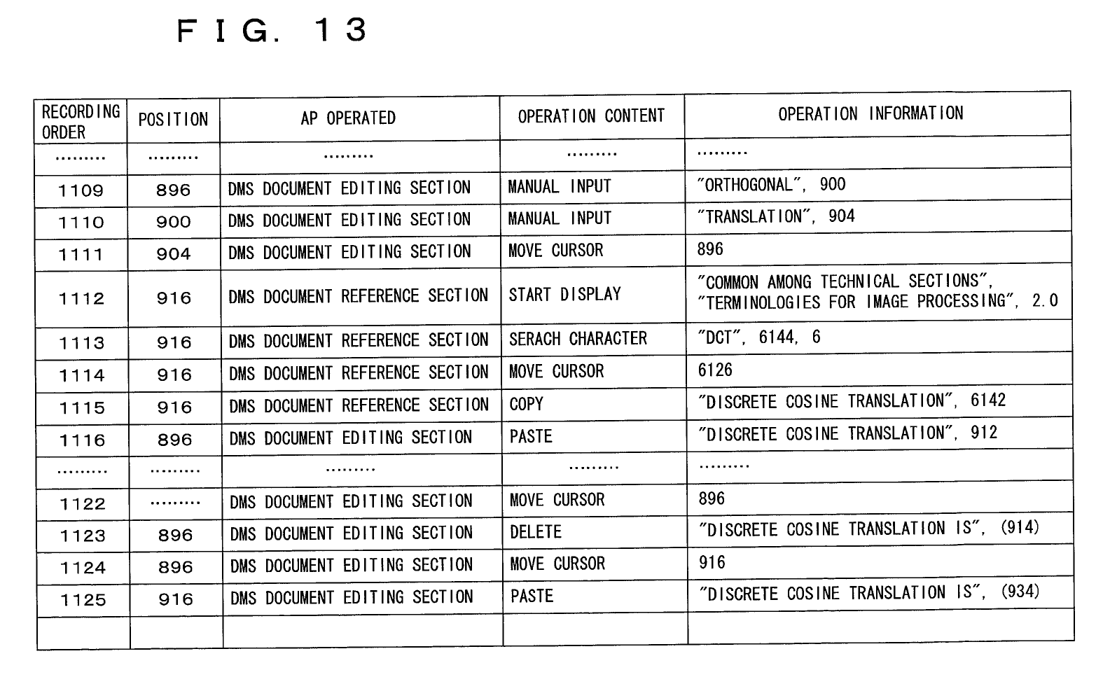

Thereafter, the phrase “discrete cosine translation is” is pasted in the same position, and as shown in FIG. 13, the mark “*” added to the position indicative information is deleted.

According to the foregoing arrangement of adding a mark to the position indicative information, whether or not respective operations stored in the log data are directly related to the current document data can be determined with ease.

### [Third Embodiment]

The following descriptions will explain the third embodiment of the present invention. In the present embodiment, the structures having the same functions as previous first and second embodiments will be designated by the same codes and their descriptions will be omitted.

In the present embodiment, detailed structure of the input/output control section 71 shown in FIGS. 3 and 4, as well as the creation of the log data and the display (reading out) of the document data using the functions of the input/output control section 71 will be explained.

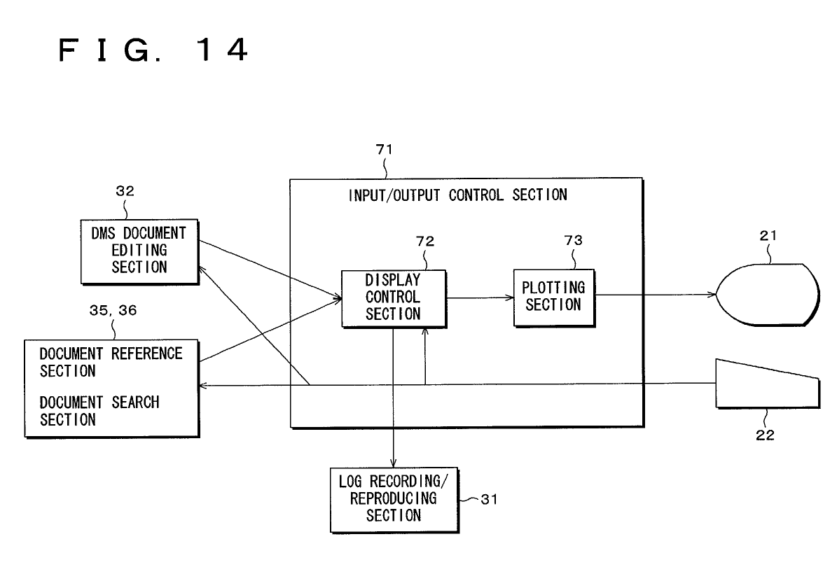

FIG. 14 is an explanatory view showing the structure of the input/output control section 71. As shown in FIG. 14, the input/output control section 71 includes a display control section 72 and a plotting section 73. The plotting section 73 outputs an image based on respective outputs from the APs 32 to 37 (see FIG. 1), and displays the image on the display device 21.

The display control section 72 observes the respective display states (the respective states of screens (windows) of the APs display (window) states of respective APs 32 to 37), and transmits the result of observation to the log recording/reproducing section 31.

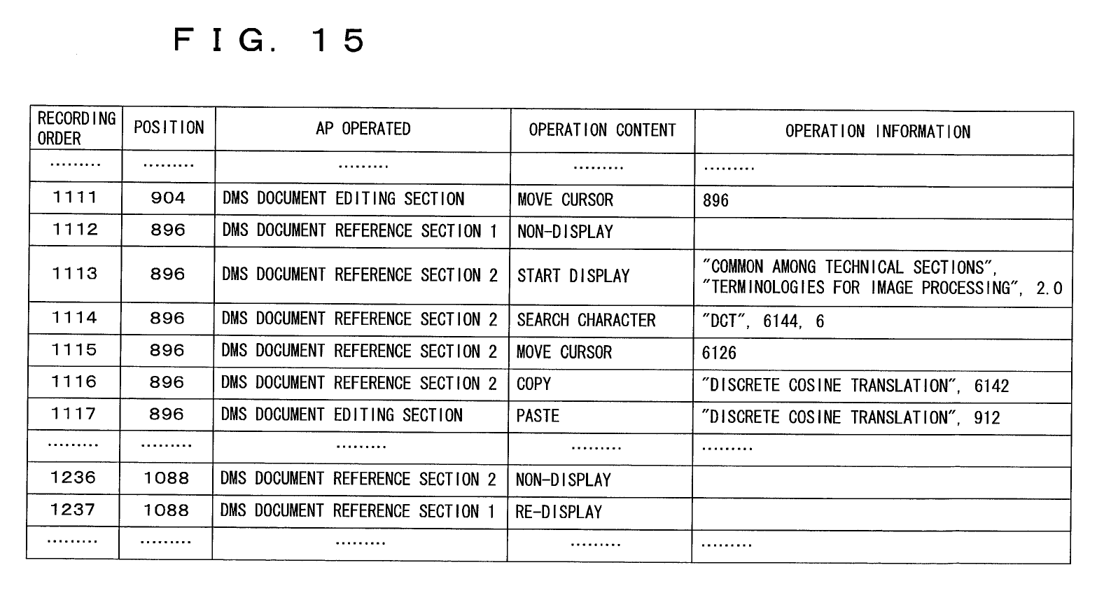

Then, in the present embodiment, as shown in FIG. 15, when creating the document data, based on the display states received from the display control section 72, the log recording/reproducing section 31 stores in the log data the information indicating whether the respective screens (windows) of the APs 32 to 37 are visible when executing respective operations (i.e., whether the respective screens are used for the creation of the document data).

Namely, in the example shown in FIG. 15, two DMS document reference sections 33 are driven when creating the document data. Then, when executing respective operations stored in the order of “1112” to “1236”, the screen of the first DMS document reference section 33 (DMS document reference section 1 in FIG. 15) is not displayed, which indicates that this first DMS document reference section 33 is not used for the creation of the document data.

Further, in this state, the second DMS document reference section 33 (the DMS document reference section 2 in FIG. 15) is displayed, which indicates that this second DMS document reference section 33 is used for the creation of the document data.

The log recording/reproducing section 31 of the present embodiment is further arranged such that in a state the document data is displayed, none of the screens of APs, hidden (not displayed) when executing respective operations, are not displayed when reproducing the document data creation process.

As a result, in the case of creating the document data in the state a plurality of screens are open, an occurrence of such problem when reading that a screen(s) irrelevant to the creation of the document data such as a screen(s) which the user forgot to close is (are) displayed at the front can be prevented.

It is preferable that conditions for determining whether a screen of each of the APs 32 to 37 is visible can be set by a user (writer of the document data).

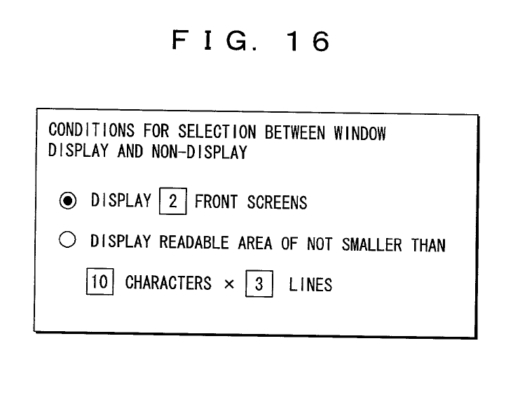

Namely, for example, the number of visible screens n from the top screen (the screen on the user side) (n=2 in the example of FIG. 16) can be set by the user, for example, by means of an input screen shown in FIG. 16. It may be also arranged such that the user sets a screen, in which not less than p lines (p=3 in the example of FIG. 16) of a character string of not less than m characters (m=10 in the example of FIG. 16) are contained in the visible area, is determined to be visible screen.

Then, the log recording/reproducing section 31 stores the display state of each screen in the log data based on the conditions set by the user in the foregoing manner. In this way, an occurrence of such problem when reproducing the creation of the document data that a screen(s) irrelevant to the creation of document data which is left open at the back, is displayed can be surely prevented.

In the above example, the log recording/reproducing section 31 stores in the log data the information indicating whether respective screen(s) (window(s)) of the APs 32 to 37 is (area) visible. However, the present invention is not limited to the above arrangement, and, for example, it may be also arranged such that the log recording/reproducing section 31 stores the display state of each screen in the log data in details (accurately). It may be further arranged such that the display state in the display device 21 can be reproduced completely when reproducing the creation of the document data. According to the foregoing arrangement, more detailed document data creation process can be provided.

### [Fourth Embodiment]

The following descriptions will explain the fourth embodiment of the present invention. In the present embodiment, the structures having the same functions as previous first through third embodiments will be designated by the same codes and their descriptions will be omitted.

The present embodiment differs from the first through third embodiments in that the log recording/reproducing section 31 stores the log data for operations executed by only a predetermined specific AP (s) and Proxy (Proxies) among the APs 32 to 37 and the Proxies 40 and 41 (see FIG. 1).

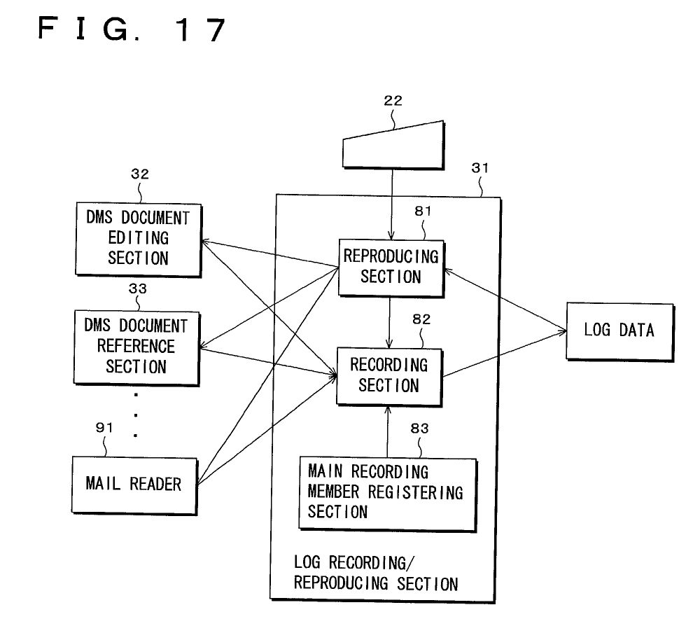

The schematic structure of the log recording/reproducing section 31 of the present embodiment is shown in the explanatory view of FIG. 17. As shown in FIG. 17, the log recording/reproducing section 31 includes a reproducing section 81, a recording section 82 and a main recording member registering section 83.

The reproducing section 81 controls the APs 32 to 37 (and proxies 40 and 41) respectively based on the log data in the state the document data is displayed (read out), to reproduce document data creation processes.

The main recording member registering section 83 is provided for registering the AP(s) and the proxy (proxies) to be stored in the log data.

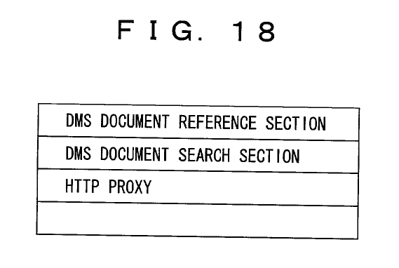

FIG. 18 is an explanatory view showing an example of a list of main recording members registered in the main recording member registering section 83. In the example of FIG. 18, the specific AP(s) and the proxy (proxies) set beforehand by the user (writer of the document data) are registered. Then, when creating the document data, the recording section 82 stores in the log data the operations executed by only the AP(s) and the proxy (proxies) registered in the list.

Therefore, according to the PC 11 of the present embodiment, such problem that operations of members (APs) irrelevant to the creation of the document data are stored in the log data can be prevented.

Assumed for example that the PC 11 includes a mail reader 91 for receiving an electronic mail (E-mail) as shown in FIG. 17. It should be noted here that an AP like the mail reader 91 is to be driven periodically irrespectively of being used or not being used for the creation of the document data. In the case where the mail reader 91 is not used for the creation of the document data, it is therefore preferable that the mail reader 91 be deleted from the list of the main recording members beforehand. In this way, the mail reader 91 can be used when creating the document data without a problem that the operation of the mail reader 91 is stored (registered) in the log data.

According to the log recording/reproducing section 31 in accordance with the present embodiment, as shown in FIG. 17, the log data can be edited by the user by directly operating the log recording/reproducing section 31 by means of the input device 22.

In this way, even if operations irrelevant to the creation of the document data are stored in the log data, such unnecessary operations can be deleted from the log data after the document data is created, or in the document data creation process. Moreover, the writer of the document data is permitted to delete the operations as he desired so as not to disclose them to readers even for the relevant operation to the creation of the document data.

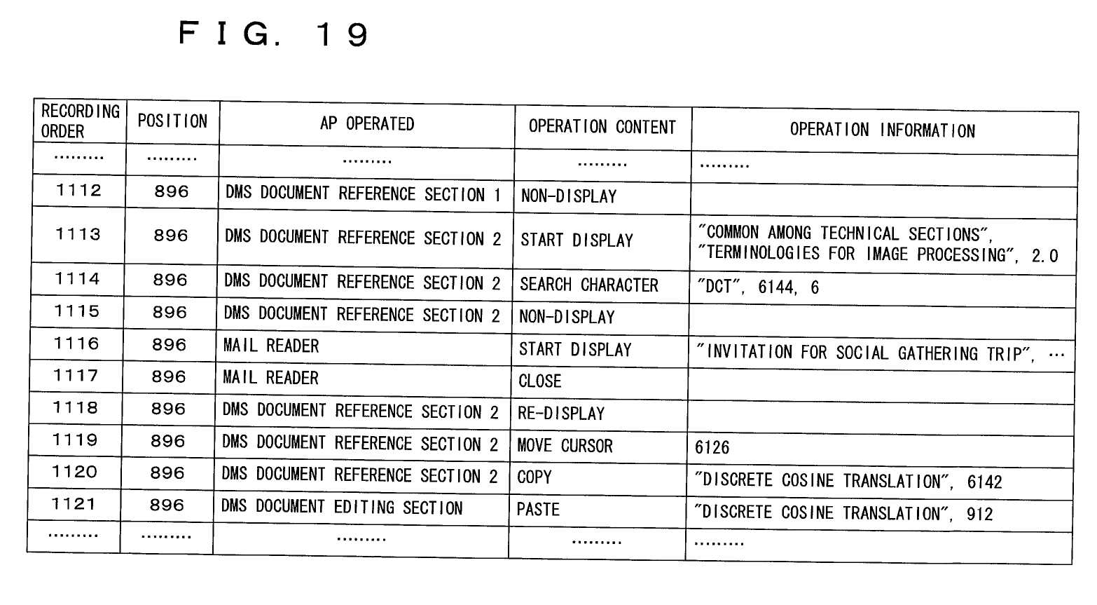

For example, as shown in the recording order “1116” and “1117” of the log data of FIG. 19, it is assumed here that a mail regarding “invitation for social gathering trip” which is irrelevant to the creation of the document data is referred to by the mail reader 91 (see FIG. 17) in the process of creating the document data.

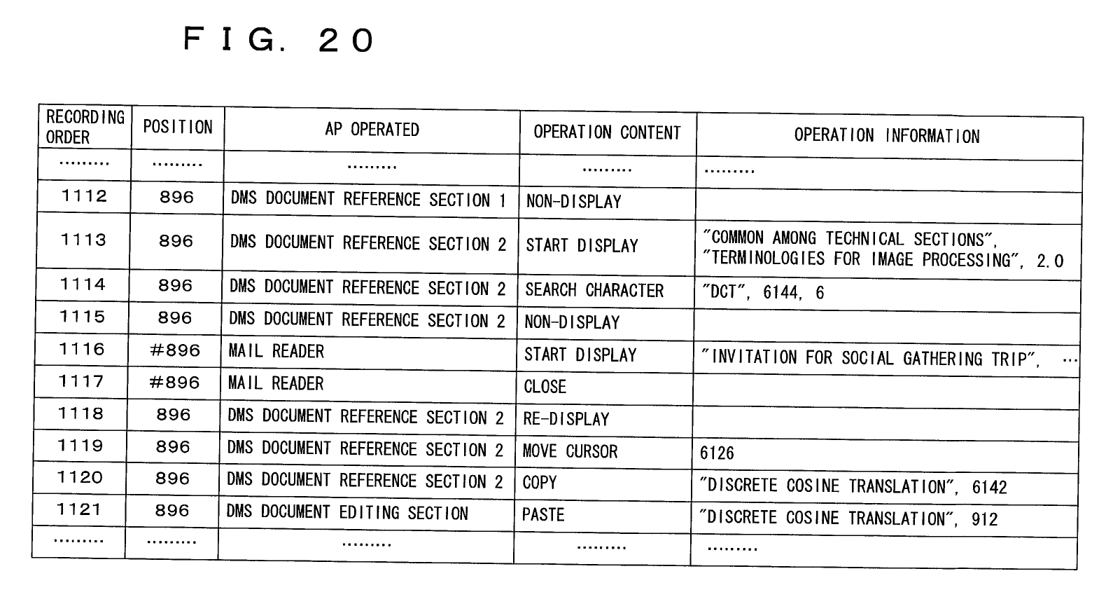

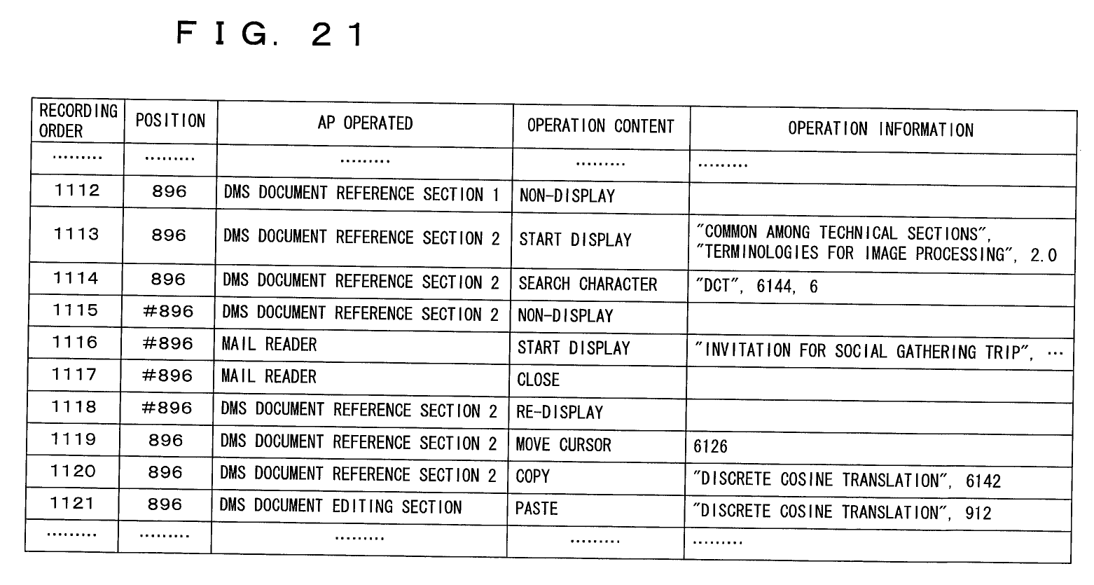

In this case, as shown in FIG. 20 or FIG. 21, for the time being, the user is permitted to set the above operation not to be displayed by adding the mark “#” to the position indicative information for the operation related to the mail reader 91 by controlling the log recording/reproducing section 31.

Then, when finally registering the document data and the log data in the DMS document management server 14, the user can delete the unnecessary operation(s) marked with “#” from the log data. As a result, when displaying the document data, an occurrence of such problem that the operation related to the mail reader 91, which is, irrelevant to the document data is reproduced can be prevented.

It may be arranged such that APs 32 to 34 and the Proxies 40 and 41 are registered in the list of main recording members shown in FIG. 18. It may be also arranged such that in replace of the proxies 40 and 41, the APs 35 to 37 controlled by the proxies 40 and 41 are registered in the list of the main recording members.

In the present embodiment, the log recording/reproducing section 31 stores in the log data the operations executed only by the predetermined specific AP(s) and Proxy (proxies). However, the present invention is not limited to the above structure, and, for example, it may be arranged such that the log recording/reproducing section 31 stores only the predetermined specific operations in the log data.

It may be further arranged such that the log recording/reproducing section 31 prevents operations (specific operations) executed by the predetermined specific AP(s) and Proxy (Proxies) from being recorded in the log data.

It should be noted here that various variations of the foregoing first through fourth preferred embodiments are permitted within the scope of the present invention, for example, as below-indicated.

The system shown in FIG. 2 may be arranged such that the DMS document management server 14 has a function of the DMS proxy.

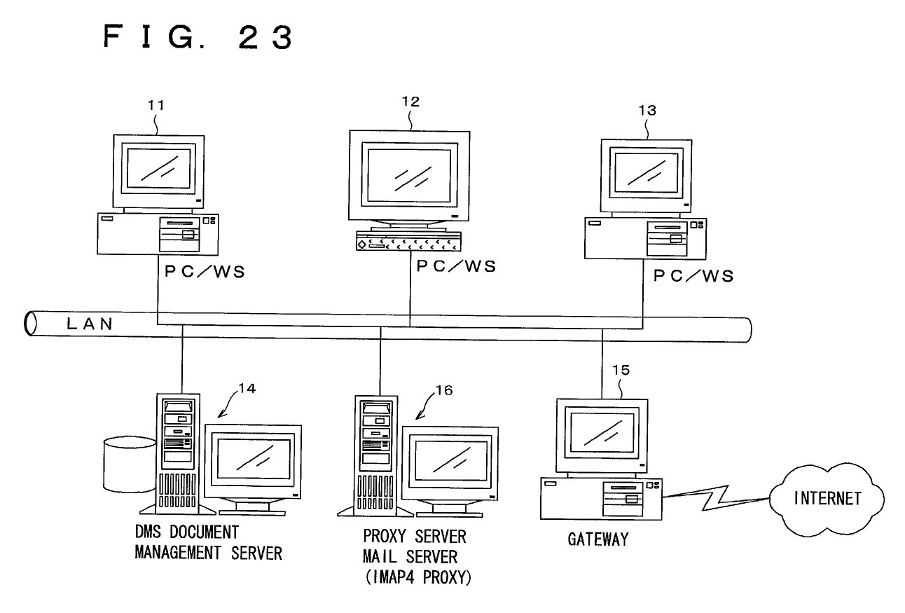

The system of the present invention may be arranged so as to include the proxy server (IMAP4 Proxy) 16 as shown in FIG. 23, and further, this proxy server may be provided with a function as a mail server. Also, the proxy server 16 may be provided with the HTTP proxy 41.

The above proxy server 16 serves as a relay when transmitting and receiving information, and is provided with a function of hooking the communication. The IMAP4 proxy is a proxy for displaying a mail (electronic mail (E-Mail), etc.) stored in the server.

The DMS document management server 14 may be provided inside the PC 11. In this arrangement, even in the place apart from the system of the present invention, the creation of the document data and the log data, and the reproduction of the creation of the document data can be performed only by means of the PC 11.

In the first through fourth embodiments, the PC 11 creates the document data by controlling respective APs 32 to 37. However, the data to be created by the PC 11 is not limited to the document data.

For example, the PC 11 may be provided with a CAD (Computer Aided Design) device for creating graphic data based on instructions given by the user by means of the input device 22, which is provided with a function of creating operation history data of all the operations it executes and transmitting the history data as created to the log recording/reproducing section 31. With this arrangement, the graphic data can be created in such a manner that the creation process of which can be reproduced.

In the foregoing first through fourth embodiments, the PC 11 is provided with the DMS document editing section 32 which permits a creation of its own operation history data as a word processor for creating the document data.

However, the present invention is not limited to the above arrangement, and, for example, it may be arranged such that the PC 11 is provided with a generally used word processor in replace of the DMS document editing section 32. In this case, it is preferable that the proxy device be provided for creating the operation history data of the word processor and transmitting the data as created to the log recording/reproducing section 31.

Namely, in the case where the PC 11 is provided with the generally used data creating section without the operation history processing section or the operation history buffer, etc., it is preferable that a proxy device for creating the operation history data of the data creating section be provided for the creation of the log data.

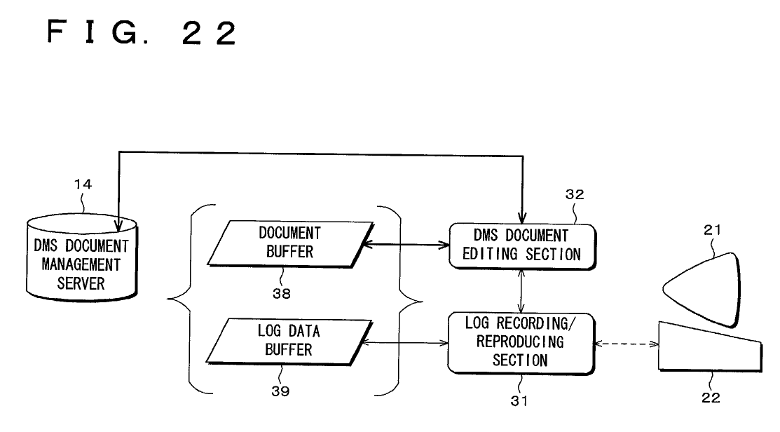

As shown in FIG. 22, it is preferable that the log recording/reproducing section 31 provided in the PC 11 stores in the DMS document management server 14 the log data and the document data stored in the log data buffer 39 and the document buffer 38 respective so as to be correlated with each other.

As a result, the recording of the document data and the log data can be controlled with ease. Moreover, the correlated pair of the document data and the log data can be read out simultaneously, and thus the reference time can be shortened.

In the first through fourth embodiments, the reproduction of the document data is performed with respect to the document data displayed on the display device 21. However, the present invention is not limited to this arrangement, and, for example, it may be arranged such that the log recording/reproducing section 31 is capable of reproducing even the creation process of the document data which has not been displayed on the display device 21 (which has not been read from the DMS document management server 14).

In the first embodiment, the log recording/reproducing section 31 is arranged so as to obtain the log data from the DMS document management server 14 upon receiving instructions for reproducing the document data creation process as displayed. However, the present invention is not limited to this arrangement, and, for example, the log recording/reproducing section 31 may be arranged so as to obtain the log data according to the document data whenever displaying the document data.

In the first embodiment, upon completing the creation of the document data, the DMS document editing section 32 and the log recording/reproducing section 31 transmit the document data and the log data to the DMS document management server 14 to be stored therein.

However, the present invention is not limited to this arrangement, and, for example, it may be arranged such that the document data and the log data are stored in the DMS document management server 14 when turning off the power of the PC 11 or stopping the function of the DMS document editing section 32.

In the first embodiment, the operation history data of the APs 32 to 37 are created by the respective operation history processing sections 53 of the APs 32 to 34, and the respective operation history processing sections 62 (see FIGS. 3 and 4) of the proxies 40 and 41, and the operation history data as created are transmitted to the log recording/reproducing section 31. However, the present invention is not limited to this arrangement, and, for example, it may be arranged such that the log recording/reproducing section 31 always observes the respective operations of the APs 32 to 37, and create the log data directly according to the operations observed, irrespectively of the operation history data.

In the first embodiment, the proxies 40 and 41 shown in FIG. 2 have functions of creating the history data of operations executed by the APs 35 to 37, and transmitting the history data to the log recording/reproducing section 31.

However, in the case of creating the history data of the APs 35 to 37 by the proxies 40 and 41, it is troublesome and time consuming to store the history data of all the operations. It may be therefore arranged such that the history data be created only by the input operation (manual input, paste, etc.) performed with respect to the document data. 183. In the first embodiment, the operation history processing section 53 shown in FIG. 3 and the operation history processing section 62 shown in FIG. 4 wrap up the operation history data by a predetermined unit (transaction) to be transmitted to the log recording/reproducing section 31. Namely, in the PC 11, the operation history data transmitted from the operation history processing sections 53 and 62 contain data indicative of the start and the end of the transaction. In the operation history processing section 62 (via the proxy etc.), the transaction can be defined only in a large unit. In contrast, in the operation history processing section 53 (in the case of dedicated AP), the transaction can be defined in a small unit.

It may be also arranged such that the unit of the operation history data transmitted by the operation history processing sections 53 and 62 is adjustable according to the purpose. For example, in the case of storing the reference to other document data or quotation of other document data for the purpose of storing the document data creation process, it is preferable that the operations such as copy, paste or the like be stored every time such operation is executed. This is because, for example, even if certain data is deleted at the end, the fact that the data is once copied is important for the document data creation process. On the other hand, as to the operation such as cursor movement, although it is possible to store each key operation, it is not necessarily to do so for such operation. Namely, in the case of cursor movement, it is sufficient to store the start position and the end position for the cursor movement at the transaction to another operation upon completing the cursor movement.

In the first embodiment, the document data and the log data are stored in the DMS document management server 14 by the DMS document editing section 32 and the log recording/reproducing section 31 upon completing the creation of the document data.

However, the present invention is not limited to this arrangement, and, for example, it may be arranged such that the document data and the log data may be maintained in the document buffer 38 and the log data buffer 39, and then the document data and the log data are read out from the document buffer 38 and the log data buffer 39 respectively when displaying the document data.

In the first through fourth embodiments, the PC 11 is provided with only the DMS document editing section 32 as the data creating section. However, the present invention is not limited to this arrangement, and, for example, it may be arranged such that a plurality of data creating sections are provided in the PCs 11 to 13 (a word processor, a CAD device, a graph creating device, etc.).

The DMS document management server 14 shown in FIG. 2 may be arranged such that the document management system (DMS) operates. For the DMS, it is required to have the functions of exclusively controlling the storage and the fetch of the document data, and may have a search function. The DMS document search section 34 may be arranged so as to search the data as desired by the user (including the document data) in the DMS document management server 14.

The example shown in FIG. 5 can be explained also as an example of the case where the operation of the DMS document search section 34 is omitted from the following process.

First, in the creation screen, the user moves a cursor as shown in (a1) in FIG. 6. Then, in order to search the word related to “orthogonal exchange”, the related reference data is fetched by controlling the DMS document search section 34 and the DMS document reference section 33.

Namely, first, the user inputs the DMS name “common among technical sections”, the reference data name “terminologies for image processing”, and the version number “2, 0” in the DMS document search section 34 via the input device 22. In response, the DMS document search section 34 fetches (reads out) the predetermined reference data from the DMS document management server 14. Thereafter, the DMS document reference section 33 displays the reference data as fetched on the reference screen of the display device 21. Then, the user inputs an instruction for searching “DCT” indicative of “orthogonal translation” in the DMS document reference section 33, and upon receiving this instruction, the DMS document reference section 33 starts a character search in the reference data by the keyword “DCT”.

In the second embodiment, it may be arranged so as to store an operation by a unit of a sentence selected by the user. It may be further arranged such that the creation process is stored and reproduced by a unit of a sentence selected by a reader. In the second embodiment, the sentence-position correspondence table is stored in the log data buffer 39; however, the correspondence table may be stored in the document buffer 38. Additionally, it is preferable that the sentence-position correspondence table be controlled by correlating the document data with the log data.

In the example of log data shown in FIGS. 9 to 13 in the second embodiment, the subject is “the operation”. Therefore, the partial data for the subject differs for each actual operation. In this example, the minimum unit of the partial data is a “character”.

Additionally, in the column “position” in the log data shown in FIGS. 8 to 10, 12 and 13, etc., a character position at a cursor (viewed with concentration as an objective of the operation) may be written. Here, a character or a chapter is fetched, and is correlated with a character position as shown in FIGS. 7(a) to 7(e) for user's convenience in executing operations, and the correlation can be determined with ease based on the form indicative information such as a period, an index, etc. Also, a word or a sentence as fetched with accuracy can be utilized in the internal process. Namely, by arranging such that the internal process can be performed by a unit of a sentence by utilizing high level language process, the position indicative information for each sentence in the document data can written in the column “position”. Additionally, in FIG. 7(e), the reason why the end position of a character is indicated by an odd number such as “0 to 25” is based on the assumption that the control code such as a change line, etc., is of 1 byte.

In the third embodiment, it may be arranged such that the log recording/reproducing section 31 selects a screen to be stored in the log data in relation to each operation according to the display state of each screen based on the condition set by the user. In this way, such problem that a screen irrelevant to the creation of the document data left open at the back is stored in relation to each operation can be surely prevented.

In the second embodiment, in the case of adopting an index as a unit of partial data, the log recording/reproducing section 31 specifies the range of an index as selected by the user based on the correspondence table as shown in FIG. 7(e), and selects the operation including the position indicative information contained in the range as specified from the log data. Then, it may be arranged such that based on the log data as selected, the log recording/reproducing section 31 controls the APs 32 to 37 (see FIG. 1) respectively, and an creation of the chapter in the index as selected is reproduced.

In the first through fourth embodiments, the log data creation process, and the reproducing process of the document data creation in the PC 11 are performed under the control of the log recording/reproducing section 31. However, the present invention is not limited to this arrangement, and, for example, an information processing device for reading a program for executing the above process as stored in a recording medium may be adopted in replace of the log recording/reproducing section 31.

In this arrangement, an arithmetic unit (CPU, MPU, etc.,) in the information processing device such as the PC 11, etc., reads out a program as stored in a recording medium, and executes reproducing processes of the log data creation process and the document data creation process. It can therefore be said that in this arrangement, the program itself executes the above processes.

Here, for the above information processing device, other than the PC 11 or generally used computers (work station, personal computer, etc.), a function extension board, a function extension unit, etc., attached to the computer may be adopted.

This program specifically indicates a software program code (execution type program, intermediate code program, source program, etc.) which realizes reproducing operations of the log data creation process, and the document data creation process. These problems may be used alone or in combination with other program (OS, etc.). Here, it may be arranged such that these programs read out from the recording medium are once stored in internal memory (RAM, etc.), and are then read out once again to be executed.

For the recording medium for recording the program, those which can be detached from the information processing device with ease, or those fixed (mounted) in the information processing device may be adopted, further those to be connected to the information processing device as external memory may be adopted.

Examples of the above recording medium include: a magnetic tape such as a video tape, a cassette tape, etc., a magnetic disk such as a floppy disk, a hard disk, etc., an optical disk (magneto-optical disk) such as a CD-ROM, an MO, an MD, a DVD, a CD-R, etc., a memory card such as an IC card, an optical card, etc., a semiconductor memory such as a mask ROM, an EPROM, an EEPROM, a flash ROM, etc.

Further, for the recording medium, those connected to the information processing device via network (intranet/internet, etc.,) may be adopted. In this case, the information processing device obtains a program by downloading via the network. Namely, the above program may be obtained from a transmission medium (medium for movably storing the program) such as network (connected to a cable line or a radio line, etc.,). Here, it is preferable that the program for downloading be stored in the device beforehand.

In the first through fourth embodiments, the DMS document editing section 32 which is a data creating section is adopted as a document creating device for creating document data according to an input instruction by the user by means of the input device 22.

However, the present invention is not limited to this arrangement, and, for example, the DMS document editing section 32 may be arranged so as to include i) a memory section for storing a program (application program) for creating the document data, and ii) a reading section for creating the document data according to an input instruction given by a user by reading the program.

Specifically, the DMS document editing section 32 can be realized, for example, by storing the above program in the memory section (not show) of the PC 11, and reading the program into the CPU (Central Processing Unit) of the PC 11, i.e., by functioning the CPU as the reading section.

Similarly, other APs 33 to 37 and Proxies 40 and 41 which serve as the data reference section may be arranged so as to include i) a memory section for storing the application program for realizing the functions of the APs and the proxies, and ii) a reading section for executing search and display of the data or the creation of the operation history data by reading the program.

In the above arrangement, the memory section and the CPU of the PC 11 may be adopted as the memory section and the reading section as in the case of the DMS document editing section 32.

In the above case of adopting the APs 32 to 37 constituted by the memory section and the reading section of the PC 11, the PC 11 serving as the information processing device of the present invention may be realized by any of the following first through fourteenth document processing devices. Further, the information processing method of the present invention can be realized by any of the following first through third document processing methods, and the recording medium of the present invention which stores a computer program for processing the document of the present invention (information processing) can be realized by the following first recording medium.

The first document processing device provided with an application program (APL) for creating document data (document file) includes a log recording/reproducing section for i) creating data (log data) including operation history data of the APL executed when creating the document data, and ii) reproducing the creation of the document data by re-executing the operation stored in the log data by the application program according to an instruction given by a reader.

Examples of the APL include a word processor, a CAD software, etc., for use in the creation of the document data, which correspond to the DMS document editing section 32, the DMS document reference section 33, the DMS document search section 34, the document reference section 35, the document search section 36 and the WEB browser 37, realized by the memory section and the reading section as above explained.

In the above structure of the first document processing device, operations of each ALP (refer to other document/drawing, input character, delete, insert, copy, paste, etc.) executed when creating the document data are stored as log data in order from the operation executed first.

Further, in the state the document data as completed is displayed, the creation of the document data can be reproduced based on an instruction given by a reader and the log data. In this way, the reader can recognize the materials such as documents, drawings, etc., referred to when creating the document data with ease. According to the above document processing device, the author of the document data is permitted to provide readers the necessary information for their understanding of the document data such as the meaning of technical terms, etc., without a need of creating auxiliary data (note, etc.) regarding the description content.

The second document processing device having the structure of the first document processing device is arranged such that the log recording/reproducing section stores in the log data all the operations executed by each APL when creating the document data, and controls each APL to re-execute its operations stored in the log data when displaying the document data, whereby all the creation processes of the document data can be reproduced.

According to the above arrangement, the background, or the author's ideas adopted for the creation of the document data can be offered to readers in details. It is therefore permitted for the reader to fully understand the document data creation process including the process of developing the authors's idea. Also for the author of the document data, the above log data reminds the author of the creation processes of the document data created in the past.

The third document processing device having the structure of the first document processing device is arranged such that the log recording/reproducing section reproduces the creation process of a part (chapter, page, index, sentence, word, character, etc.) as selected by the reader. In this way, only a predetermined part as selected by the reader can be reproduced, and thus a reference time can be shortened.

The fourth document processing device having the structure of the third document processing device is arranged such that when creating the document data, the log recording/reproducing section stores the position indicative information of a related part of each operation (a part created by each operation) on the document data in the log data in relation to each operation. According to this arrangement, the related operation can be fetched with ease when reproducing the document data by each portion.

The fifth document processing device having the structure of the fourth document processing device is arranged such that the above log recording/reproducing section changes the position indicative information already recorded in the log data as necessary according to the change (insert, delete, etc.,) made in the document data.

When a change is made in the part already created, the position indicative information of the part after the change differs from the position indicative information already stored. Therefore, by changing the position indicative information recorded in the log data according to the change made in the document data as in the above arrangement, the correct correlation between the actual position indicative information and the position indicative information on the log data can be maintained.

The sixth document processing device having the structure of the fifth document processing device is arranged such that when making a deletion in the document data, the log recording/reproducing section marks an operation related to the deleted portion in the document data with a predetermined mark on the log data. According to this arrangement, it can be determined with ease whether each operation stored in the log data is directly related to the current document data.

The seventh document processing device having the structure of the sixth document processing device is arranged such that in the case where the deleted part is recovered, the log recording/reproducing section deletes the mark added to the log data, which can manage the case of cancelling the deletion, or performing cut, paste, etc.

The eighth document processing section having the structure of the first document processing device is arranged such that each of the APLs includes an operation history data creating section for creating the history data of its operations and transmitting the operation history data as created to the log recording/reproducing section. According to this arrangement, since each APL creates the history data of its operations, detailed log data can be stored.

The ninth document processing device having the structure of the first document processing device is arranged so as to include an APL supervision section (DMS proxy 40, HTTP proxy 41) for creating the operation history data of the APLs and transmitting the operation history data as created to the log recording/reproducing section. As a result, the log data can be created even when creating the document data by an APL which is not provided with the operation history data creating section.

Additionally, this APL supervision section includes a memory section for recording the program for executing the function of the APL supervision section and a reading section for reading the program to be executed.

The tenth document processing device having the structure of the first document processing device is arranged so as to include a display control section for supervising the display state on the display screen for each APL, and the log recording/reproducing section records the information of the screen displayed when executing each operation in the log data by controlling this display control section.

According to the above arrangement, a change made between display and non-display of each ALP and the display content can be recorded in the log data. Moreover, when creating the document in the state where a plurality of screens (windows) are open, an occurrence of such problem that a screen(s) irrelevant to the creation of the document data such as a screen(s) which was (were) forgotten to be closed is (area) displayed when viewing can be prevented.

The eleventh document processing device having the structure of the tenth document processing device is arranged such that the log recording/reproducing section selects a screen to be recorded in the log data in relation to each operation according to the display state of each screen.

The display state specifically indicates a size, a display area (a visible area) of each screen, a position of each screen (whether the screen is positioned at the front), etc. According to the foregoing arrangement, an occurrence of such problem that an irrelevant screen(s) left at the back is (are) stored in relation to each operation can be avoided. Additionally, in the above arrangement, it is preferable to arrange such that the condition for the display screen to be stored in the log data can be set by the user.

The twelfth document processing section having the structure of the first document processing section is arranged such that the log recording/reproducing section records in the log data only the operation related to a specific predetermined APL. As a result, such problem that the operation of the APL(s) irrelevant to the creation of the document data creation is recorded in the log data can be prevented.

The thirteen document processing device having the structure of the first document processing device is arranged such that the log recording/reproducing section has a function of editing the log data according to an instruction given by the user.

According to the foregoing arrangement, an operation irrelevant to the creation of the document data can be deleted from the log data after the document data is created. Moreover, a writer of the document data is permitted to delete the operations as he desires so as not to disclose them to a reader(s) even for the relevant operation of the APL to the creation of the document data.

The fourteenth document processing device having the structure of the first document processing device is arranged so as to include a memory section for storing (registering) the document data created by each APL in relation to the log data created by the log recording/reproducing section. According to this arrangement, the recording of the document data and the log data can be controlled with ease. Moreover, the correlated pair of the document data and the log data can be read out simultaneously, and thus the reference time can be shortened.

The first document processing method for creating document data by an APL includes (a) a log data creating step for creating data (log data) including the operation history of the APL executed when creating the document data, and (b) a reproducing step of reproducing the creation of the document data by re-execute the operation stored in the log data by the APL according to an instruction given by the reader.

The second document processing device having the structure of the first document processing device is arranged such that: in the log data creation step, all the operations executed by each APL are stored in the log data, and in the reproducing step, the respective APLs re-execute all the operations as stored in the log data, whereby all the creation processes of the document data can be reproduced.

The third document processing method having the structure of the first document processing method is arranged such that in the reproducing step, the reproduction of the creation process is performed by a portion selected by the reader (chapter, page, index, character, word, character, etc.).

The first recording medium storing a computer program for processing document to create document data by an APL realizes a reproduction of a creation of the document data by creating data (log data) including history data of an operation executed by the APL when creating the document data, and re-executing the operation stored in the log data based on an instruction given by the reader, whereby the creation process of the document data can be reproduced.

The information processing device of the present invention for creating/displaying the data file includes: a data creating section for creating data file, a data reference section for displaying the reference data, and a log recording/reproducing section for creating log data composed of operation history executed by the data creating section and the data reference section when creating the data file, and reproducing the creation of the data file by controlling the data creating section and the data reference section to re-execute the operation recorded in the log data, so as to reproduce the creation of the data file. It may be further arranged such that the log recording/reproducing section reproduces a creation process of partial data as selected by the reader when displaying the data file.

In the above arrangement, when creating the data file, the log recording/reproducing section stores in the log data position indicative information on the data file in the partial data related to each operation executed by the data creating section and the data reference section, in relation to each operation.

Here, the partial data related to each operation indicates partial data created by each operation or partial data being created when executing the above process. According to the above arrangement, when reproducing the partial data, an operation regarding the partial data can be extracted with ease.

Here, it is preferable that the log recording/reproducing section changes the position indicative information of the partial data already stored in the log data according to the change made in the data file. Here, a change in data file specifically indicates a change made in the already created partial data, examples of which include insert, delete, etc, of character with respect to the document data.

When a change is made in the part already created, the position indicative information of the part after the change differs from the position indicative information already stored. Therefore, by changing the position indicative information of the partial data stored in the log data according to the change made in the data file as in the above arrangement, correct correlation between actual position indicative information and the position indicative information stored in the log data can be maintained.

In the above arrangement, it is preferable that when making a deletion in the data file, the log recording/reproducing section marks an operation related to the deleted portion in the data file with a predetermined mark on the log data.

In the case of re-inputting the deleted partial date, it is preferable that the mark added to the log data be erasable.

According to the above arrangement, whether each operation as stored in the log data is directly related to the partial data remaining in the data file can be determined with ease. Here, by setting the mark erasable, the device of the present invention can manage the case of cancelling the deletion, or performing cut, paste, etc.

As described, the information processing device of the present invention for creating and displaying data file includes a data creating section for creating the data file, a data reference section for displaying reference data, and a log recording/reproducing section for i) creating log data including history data of operations executed by the data creating section and the data reference section when creating the data file, and ii) controlling the data creating section and the data reference section to re-execute the operations as stored in the log data when displaying the data file, whereby the creation of the data file can be reproduced.

According to the above arrangement of the information processing device, the log recording/reproducing section stores in the log data the operations executed by the data creating section and the data reference section when creating the data file in order from the operation executed first. Then, when displaying the data file as completed, the log recording/reproducing section enables the reproduction of the operations executed by the data creating section and the data reference section executed in the creation of the data file based on an instruction given by the reader and the log data.

As a result, the reader can recognize the operation history such as input, deletion made with respect to the content of the data file as well as the materials referred to when creating the document data. Therefore, according to the above arrangement, the user can follow the process of creating the data file with ease.

According to the above document processing device, the writer of the data file is permitted to provide a reader(s) the necessary information for his (their) understanding of the data file such as the meaning of technical terms, specific symbols, etc., without a need of creating auxiliary data (note, etc.) on the content of the data file.

In the above arrangement, it is preferable that the log recording/reproducing section store all the operations executed by the data creating section and the data reference section stored in the log data when creating the document data, and controls the data creating section and the data reference section to re-execute all the operations in the log data when displaying the document data, whereby all the creation processes of the data file can be reproduced.

According to the above arrangement, operations executed for the creation of the data file can be offered to a reader(s) in details. It is therefore permitted for the reader to fully understand the document data creation process including the reference data which is not directly relevant to the data file, and the authors's idea adopted for the creation of the document data. Also for the author of the document data, the above log data reminds the author of the creation processes of the data file created in the past.

Also, it may be arranged such that the log recording/reproducing section reproduces a creation process of a partial data as selected by the reader when displaying the data file.

Here, the partial data of the data file indicates chapter, page, sentence, word, character, etc. for the document data. According to this arrangement, only a predetermined portion as selected by the reader can be reproduced, and thus the reader can obtain necessary information in a short reference time.

In the above arrangement, it is preferable that when creating the document data, the log recording/reproducing section stores in the log data a position on data file of the related portion of each operation as position indicative information of each operation.

Further, it is preferable that the log recording/reproducing section specifies the position of the partial data as selected by the reader when displaying the data file, and selects the operation related to the partial data based on the position indicative information as selected from the log data so as to be re-executed by the data creating section and the data reference section.

Here, the related portion of each operation indicates a portion created by each operation, or a part being created when performing each operation. Here, in this arrangement, when creating the data file, the log recording/reproducing section stores in the log data the position of the related part of each operation (position on the data file) as position indicative information of each operation.

Further, when reproducing the partial data as selected by the reader, the log recording/reproducing section specifies the position of the partial data and compares the position of the partial data as specified with the position indicative information of each operation, whereby the operation related to the partial data can be selected with ease. As a result, the partial data can be reproduced with ease.

A unit of data to be recognized as a related portion of each operation is not limited; however, it is preferable that the unit be smaller than the partial data.

In this case, it is preferable that the log recording/reproducing section changes the position indicative information of each operation already stored in the log data according to a change made in the data file.

Here, a change in the data file specifically indicates a change made in the already created portion, and for example, insert or deletion of character, etc., made in the document data.

Furthermore, a change is made in the portion already created, other positions than the portion subjected to the change should also be changed, resulting in incorrect correlation between the position indicative information on the log data and the actual position. Therefore, by changing the position indicative information of each operation stored in the log data according to a change made in the data file as in the above arrangement, correct correlation between the position of each portion in the data file and the position indicative information of the related operations can be maintained.

In this arrangement, when making a deletion in the data file, it is preferable that the log recording/reproducing section marks an operation related to the part subjected to the deletion in the data file by a predetermined mark on the log data.

It is also preferable that the log recording/reproducing section deletes the mark added to the log data when re-inputting the deleted part.

According to this arrangement, whether each operation stored in the log data is directly relevant to a portion remaining in the data file can be determined with ease. Here, by setting the mark erasable, the device of the present invention can manage the case of cancelling the deletion, or performing cut, paste, etc.

In the information processing device of the present invention, it is preferable that the data creating section and the data reference section include the operation history data creating section which creates the history data of the operations they executed and transmits the history data as created to the log recording/reproducing section.

According to the above arrangement, since the history data of respective operations performed by the data creating section and the data reference section are created by themselves, detailed log data can be stored, and the number of processes to by performed by the log recording/reproducing section can be reduced.

It is also preferable that the information processing device is provided with an operation supervision section for creating history data of operations executed by the data creating section and the data reference section and transmitting the history data as created to the log recording/reproducing section.

According to the above arrangement, even when creating the data file by the data creating section and the data reference section which are not provided with the operation history data creating section, it is possible to create the operation history data by the operation supervision section. Therefore, the log data can be created desirably, and the number of processes to be performed by the log recording/reproducing section can be reduced.

It is also preferable that the information processing device includes a display control section for supervising the display state of the display screen which is open when creating the data file. Further, it is preferable that the log recording/reproducing section controls this display control section to record in the log data the display state of the screen which is open when executing each operation.

The display screen(s) indicates a window(s) to be opened on the display device for a kind of the data file or the reference data, or a kind of the data creating section and the data reference section.

According to the above arrangement, the information regarding the display screen(s) used in the creation of the data file can be stored in the log data. Therefore, in the state the data file is displayed, even the state of the display screen can be reproduced accurately. As a result, the detailed processes of creating the data file can be offered.

In the above arrangement, it is preferable that the log recording/reproducing section determines whether each screen is used for the creation of the data file based on the display state of the display screen, and records the result of determination in the log data.

According to the above arrangement, the log recording/reproducing section determines whether each screen is used for the creation of the data file according to the display state of each screen. Then, upon determining that the screen is not used for the creation of the data file, the information indicating that the screen is irrelevant to the creation of the data file is stored in the log data.

According to this arrangement, such program that a screen irrelevant to the creation of data file, which is left open at the back is stored in relation to each operation can be avoided. Here, the display state specifically indicates a size, a display area (a visible area) of each screen, a position of each screen (whether the screen is positioned at the front), etc.

In the above arrangement, preferably, the correlation between i) whether each screen is used for the creation of the data and ii) display state can be set by the user. Namely, it is preferable that the log recording/reproducing section determines whether the display screen is used for the creation of the data based on the determination condition (display condition) set by the user. The determination condition indicates the condition based on which whether each screen is used for the creation of the data is determined.

It is also preferable that the log recording/reproducing section stores in the log data the operations executed by only the predetermined data creating section and the data reference section.

According to the above arrangement, in the case where the data creating section and the data reference section which are irrelevant to the creation of the data file are provided in the information processing device, such problem that these operations are stored in the log data can be prevented. Therefore, when reproducing the creation of the data file, reproduction of the irrelevant operations can be avoided.

Additionally, in the information processing device of the present invention, it is preferable that the log recording/reproducing section be provided with a function of editing the log data according to an instruction given by the user.

With this arrangement, operations irrelevant to the creation of the data file can be deleted from the log data after the creation of the data file (or in the process of the creating the data file). Moreover, the writer of the document data is permitted to delete the operation(s) as he desires so as not to disclose them to readers even for the relevant operation to the creation of the data file.

It is also preferable that the information processing device of the present invention includes data memory section for storing the data file as created by the data creating section in relation to the log data created by the log recording/reproducing section.

According to this arrangement, the storage of the data file and the log data can be controlled (registered) with ease. Moreover, the correlated pair of the document data and the log data can be read out simultaneously, and thus the reference time can be shortened.

The information processing device of the present invention may be arranged such that the data creating section includes a memory section for storing a program for creating the data file and a reading section for creating the data file by reading the program.

Similarly, the data reference section may be arranged so as to include a memory section for storing a program for making a reference to the data file, and a reading section for making a reference to the data file by reading the program.

The information processing method of the present invention for i) creating data file using a data creating section for creating data file, and a data reference section for displaying reference data ii) displaying the data file as created includes: (a) a log data creation step for creating log data including history data of operations executed by the data creating section and the data reference section when creating the log data, and (b) a reproducing step for reproducing a creation of data file by re-executing the operations stored in the log data by the data creating section and the data reference section.

According to the information processing method, in the log data creating step, the operations of the data creating section and the data reference section executed in the creation of the data file can be stored as log data from the operation executed first.

Additionally, when displaying the data file as completed, in the reproducing step, operations of the data creating section and the data reference section executed in the creation of the data file can be reproduced based on an instruction of the reader and the log data.

As a result, the reader can see the history of input/deletion made with respect to the content of the data file, and the materials referred to when creating the data file, thereby permitting the reader to follow the data file creation processes with ease.

According to the above document processing device, the writer of the data file is permitted to provide a reader(s) the necessary information for his (their) understanding of the document data such as the meaning of technical terms, specific symbols, etc., without a need of creating auxiliary data (note, etc.) regarding the description content of the data file.

It is also preferable that the above information processing method be arranged such that in the log data creating step, all the operations executed by the data creating section and the data reference section are recorded in the log data, and in the reproducing step, all the operations stored in the log data are re-executed by the data creating section and the data reference section, whereby all the creation of the data file can be reproduced.

According to the above method, the detailed operations executed for the creation of the data file can be offered to the reader. Therefore, the reader can fully understand even the reference data which is not very relevant to the data file as well as the author's ideas adopted for the creation of the data file. Also for the author of the document data, the above log data reminds the author of the creation processes of the document data created in the past.

It may be arranged such that in the reproducing step, the creation process of the partial data as selected by the reader is reproduced.

Here, the partial data is a portion of the data file, such as chapter, page, sentence, word, character, etc. in the case of the document data. According to this method, since only a predetermined portion desired by the reader can be reproduced, the reader can obtain the necessary information in a short reference time.

A recording medium of the present invention storing a computer program for processing information, which i) creates data file using a data creating section for creating a data file and a data reference section for displaying reference data, and ii) displays a data file as created is arranged so as to a reproduction of a creation of data file by creating log data including history data of operations executed by the data creating section and the data reference section when creating the data file, and re-executing the operations as stored in the log data by the data creating section and the data reference section, whereby the creation of the data file can be reproduced.

By installing the above recording medium in the control device provided in a generally used information processing device such as a personal computer, etc., the foregoing information processing device and the information processing method of the present invention can be realized with ease.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. An information processing device for creating and displaying a data file, comprising:
a data creating section for creating the data file;
a data reference section for displaying reference data; and
a log recording/reproducing section which i) creates log data including history data of operations executed by said data creating section and said data reference section when creating the data file, and ii) controls said data creating section and said data reference section to re-execute the operations stored in the log data so as to reproduce a creation of the data file when displaying the data file.

2. The information processing device as set forth din claim 1, wherein:
said log recording/reproducing section records all the operations executed by the data creating section and the data reference section in the log data when creating the data file, and
controlling the data creating section and the data reference section to re-execute all the operations stored in the log data, so as to reproduce all the creation processes of the data file when displaying the data file.

3. The information processing device as set forth in claim 1, wherein:
said log recording/reproducing section reproduces creation processes of partial data as selected by the reader when displaying the data file.

4. The information processing device as set forth in claim 3, wherein:
when creating the data file, said log recording/reproducing section records a position on the data file in a related portion of each operation executed by the data creating section and the data reference section as the position indicative information of each operation, and
when displaying the data file, said log recording/reproducing section specifies the position of the partial data as selected by the reader, and based on the position indicative information, selects the operation related to the partial data from the log data, to be re-executed by said data creating section and said data reference section.

5. The information processing device as set forth in claim 4, wherein:
said log recording/reproducing section changes the position indicative information of each operation as already stored in the log data according to a change made in the data file.

6. The information processing device as set forth in claim 5, wherein:
when a deletion is made with respect to the data file, said log recording/reproducing section marks an operation related to the deleted portion on the log data with a predetermined mark.

7. The information processing device as set forth in claim 6, wherein:
when a deleted portion is re-inputted, said log recording/reproducing section deletes the mark from the log data.

8. The information processing device as set forth in claim 1, wherein:
said data creating section and said data reference section respectively provided with operation history data creating sections for creating history data of operations they executed and transmitting the history data as created to said log recording/reproducing section.

9. The information processing device as set forth in claim 1, comprising:
an operation supervision section for creating history data of operations executed by said data creating section and said data reference section and transmitting the history data as created to said log recording/reproducing section.

10. The information processing device as set forth in claim 1, further comprising:
a display control section for supervising a display state of a display screen which is open when creating the data file,
wherein said log recording/reproducing section controls said display control section so as to store in the log data a display state of the screen opened when executing each operation.

11. The information processing device as set forth in claim 10, wherein:
said log recording/reproducing section determines whether each screen is used in the creation of the data file based on the display state of the display screen, and stores the result of determination in the log data.

12. The information processing device as set forth in claim 11, wherein:
said log recording/reproducing section determines whether the display screen is used for the data creation based on a determination condition set beforehand by the user.

13. The information processing device as set forth in claim 1, wherein:
said log recording/reproducing section stores only operations executed by predetermined specific data creating section and data reference section in the log data.

14. The information processing device as set forth in claim 1, wherein:
said log recording/reproducing section prevents operations executed by predetermined specific data creating section and said data reference section from being stored in the log data.

15. The information processing device as set forth in claim 1, wherein:
said log recording/reproducing section edits the log data according to an instruction given by the user.

16. The information processing device as set forth in claim 1, further comprising:
a data recording section for storing the data file created by said data creating section in relation to the log data created by said log recording/reproducing section.

17. The information processing device as set forth in claim 1, wherein:
said data creating section includes a memory section for storing a program for creating the data file and a reading section for creating the data file by reading the program.

18. The information processing device as set forth in claim 1, wherein:
said data reference section includes a memory section for storing a program for making a reference to the data file, and a reading section for making a reference to the data file by reading the program.

19. The information processing device as set forth in claim 1, wherein:
said data creating section creates document data.

20. An information processing method for i) creating data file using a data creating section for creating data file and a data reference section for displaying reference data and ii) displaying the data file as created, comprising:
(a) a log data creation step for creating log data including history data of operations executed by said data creating section and said data reference section when creating the data file; and
(b) a reproducing step for controlling said data creating section and said data reference section to re-execute the operations stored in the log data to reproduce a creation of the data file.

21. The information processing method as set forth in claim 20, wherein:
in said reproducing step, all the operations stored in the log data are re-executed by said data creating section and said data reference section to reproduce all the creation processes of the data file.

22. The information processing method as set forth in claim 20, wherein:
in said reproducing step, creation processes of partial data selected by the reader are reproduced.

23. A recording medium storing a computer program for processing information, which i) creates data file using a data creating section for creating a data file and a data reference section for displaying reference data, and ii) displays a data file as created, wherein:
a reproduction of a creation of a data file is realized by creating log data including history data of operations executed by said data creating section and said data reference section when creating the data file, and re-executing the operations as stored in the log data by said data creating section and said data reference section.
